(19) United States
(12) Patent Application Publication
(10) Pub. No.: US 2016/0275567 A1
(43) Pub. Date: Sep. 22, 2016

(54) METHOD AND SYSTEM FOR ADVERTISEMENT COORDINATION

(71) Applicant: YAHOO! INC., Sunnyvale, CA (US)

(72) Inventors: Hao Zheng, Beijing (CN); Huiting Liu, Beijing (CN); Hongwei Zeng, Beijing (CN); Li Rong, Beijing (CN)

(21) Appl. No.: 14/408,192

(22) PCT Filed: Jun. 4, 2014
(86) PCT No.: PCT/CN2014/079146

§ 371 Date: Dec. 15, 2014

(51) Int. Cl. G06Q 30/02

(52) U.S. Cl. CPC G06Q 30/0275; G06Q 30/0277; G06Q 30/0242

(57) ABSTRACT

Method and system for advertisement coordination through online bidding are provided. In one example, a bid request is received with respect to a plurality of advertisement opportunities. The plurality of advertisement opportunities is related to an online service. A plurality of advertisements is determined in accordance with the plurality of advertisement opportunities. An online bid associated with the plurality of advertisements is generated based on the bid request. The online bid is transmitted as a response to the bid request.

### CROSS-REFERENCE TO RELATED APPLICATIONS

The present application is related to a PCT Patent Application having an attorney docketing No. 022994-0430761, filed on even date, entitled METHOD AND SYSTEM FOR ADVERTISEMENT COORDINATION, a PCT Patent Application having an attorney docketing No. 022994-0430770, filed on even date, entitled METHOD AND SYSTEM FOR ADVERTISEMENT COORDINATION, a PCT Patent Application having an attorney docketing No. 022994-0430771, filed on even date, entitled METHOD AND SYSTEM FOR ADVERTISEMENT COORDINATION, a PCT Patent Application having an attorney docketing No. 022994-0430776, filed on even date, entitled METHOD AND SYSTEM FOR ADVERTISEMENT COORDINATION, all of which are incorporated herein by reference in their entireties.

### BACKGROUND

1. Technical Field

The present teaching relates generally to online advertisements. Specifically, the present teaching relates to method and system for advertisement coordination through online bidding.

2. Discussion of Technical Background

The advancement in the Internet has made it possible to sell and buy online products or services through the Internet. Online bidding is a method for buyers to bid on their interested online products or services. For example, when an opportunity for online advertising is available at an online publisher (e.g., a web portal), a bid request for advertising on the available online space or spot is sent to one or more ad exchange engines, e.g., from the publisher. The ad exchange engine(s) may represent a plurality of advertisers that determine an advertisement based on the bid request, generate a bid associated with the advertisement, and return the bid as a response to the bid request.

Effort has been made to optimize advertisements for ensuring user experience with online advertising and improving return of investment for the advertisers. Typically, however, different online advertisements are selected and optimized independently from each other and compete against each other for limited user attention, even if the online advertisements are presented to a user on a same web page, via a same application, or in a same user session. In addition, conventional approaches do not include online bidding for a plurality of advertisements or advertisement opportunities to be presented to a user, e.g., during a same session and/or on a same webpage/application based on a coordination of, or a relationship between, the advertisements.

Therefore, there is a need for a method and system to coordinate advertisements through online bidding and avoid the above drawbacks.

### SUMMARY

The present teaching describes methods, systems, and programming for advertisement coordination through online bidding.

In one example, a method, implemented on at least one machine each having at least one processor, storage, and a communication platform connected to a network for generating an online bid is presented. A bid request is received, via the communication platform, with respect to a plurality of advertisement opportunities. The plurality of advertisement opportunities is related to an online service. A plurality of advertisements is determined in accordance with the plurality of advertisement opportunities. An online bid associated with the plurality of advertisements is generated based on the bid request. The online bid is transmitted as a response to the bid request.

In another example, a method, implemented on at least one machine each having at least one processor, storage, and a communication platform connected to a network for managing online bidding is presented. A bid request is generated with respect to a plurality of advertisement opportunities. The plurality of advertisement opportunities is related to an online service. The bid request is transmitted, via the communication platform, to one or more online bidders. One or more online bids are received from the one or more online bidders. Each of the one or more online bids is associated with the plurality of advertisement opportunities. A winning bid is determined from the one or more online bids. A plurality of advertisements associated with the winning bid is identified.

In yet another example, a system, having at least one processor, storage, and a communication platform connected to a network for generating an online bid, is presented. The system comprises a bid request analyzer, an ad determiner, and a bid generator. The bid request analyzer is configured to receive, via the communication platform, a bid request with respect to a plurality of advertisement opportunities. The plurality of advertisement opportunities is related to an online service. The ad determiner is configured to determine a plurality of advertisements in accordance with the plurality of advertisement opportunities. The bid generator is configured to generate an online bid associated with the plurality of advertisements based on the bid request and transmit the online bid as a response to the bid request.

In a different example, a system, having at least one processor, storage, and a communication platform connected to a network for managing online bidding, is presented. The system comprises a bid requestor, a bid receiver, a bid selector, and an ad requestor. The bid requestor is configured to generate a bid request with respect to a plurality of advertisement opportunities and transmit the bid request to one or more online bidders. The plurality of advertisement opportunities is related to an online service. The bid receiver is configured to receive one or more online bids from the one or more online bidders. Each of the one or more online bids is associated with the plurality of advertisement opportunities. The bid selector is configured to determine a winning bid from the one or more online bids. The ad requestor is configured to identify a plurality of advertisements associated with the winning bid.

Other concepts relate to software for generating an online bid and managing online bidding. A software product, in accord with this concept, includes at least one non-transitory machine-readable medium and information carried by the medium. The information carried by the medium may be executable program code data regarding parameters in association with a request or operational parameters, such as information related to a user, a request, or a social group, etc.

In one example, a machine-readable tangible and non-transitory medium having information for generating an online bid is presented. The information, when read by the machine, causes the machine to perform the following. A bid request is received, via the communication platform, with respect to a plurality of advertisement opportunities. The plurality of advertisement opportunities is related to an online service. A plurality of advertisements is determined in accordance with the plurality of advertisement opportunities. An online bid associated with the plurality of advertisements is generated based on the bid request. The online bid is transmitted as a response to the bid request.

In another example, a machine-readable tangible and non-transitory medium having information for managing online bidding is presented. A bid request is generated with respect to a plurality of advertisement opportunities. The plurality of advertisement opportunities is related to an online service. The bid request is transmitted, via the communication platform, to one or more online bidders. One or more online bids are received from the one or more online bidders. Each of the one or more online bids is associated with the plurality of advertisement opportunities. A winning bid is determined from the one or more online bids. A plurality of advertisements associated with the winning bid is identified.

### BRIEF DESCRIPTION OF THE DRAWINGS

The embodiments will be more readily understood in view of the following description when accompanied by the below figures and wherein like reference numerals represent like elements, wherein:

FIG. 1 is a high level depiction of an exemplary networked environment for advertisement coordination through online bidding, according to an embodiment of the present teaching;

FIG. 2 is a high level depiction of another exemplary networked environment for advertisement coordination through online bidding, according to an embodiment of the present teaching;

FIG. 3 illustrates an exemplary diagram of a publisher for managing online bidding, according to an embodiment of the present teaching;

FIG. 4 is a flow chart of an exemplary process for managing online bidding, in accordance with one embodiment of the present teaching;

FIG. 5 illustrates an exemplary diagram of a bid mode controller in a publisher, according to an embodiment of the present teaching;

FIG. 6 is a flow chart of an exemplary process performed at a bid mode controller, according to an embodiment of the present teaching;

FIG. 7 illustrates an exemplary diagram of a bid requestor in a publisher, according to an embodiment of the present teaching;

FIG. 8 is a flow chart of an exemplary process performed at a bid requestor, according to an embodiment of the present teaching;

FIG. 9 illustrates an exemplary diagram of an ad exchange engine for generating an online bid, according to an embodiment of the present teaching;

FIG. 10 is a flow chart of an exemplary process performed at an ad exchange engine, according to an embodiment of the present teaching;

FIG. 11 illustrates an exemplary diagram of an independent advertiser, according to an embodiment of the present teaching;

FIG. 12 is a flow chart of an exemplary process performed at an independent advertiser, according to an embodiment of the present teaching;

FIG. 13 illustrates an exemplary diagram of a bid server in an ad exchange engine or in an independent advertiser, according to an embodiment of the present teaching;

FIG. 14 is a flow chart of an exemplary process performed at a bid server, according to an embodiment of the present teaching;

FIG. 15A illustrates an exemplary process between a publisher and an ad exchange engine or an independent advertiser in accordance with a first bid mode, according to an embodiment of the present teaching;

FIG. 15B is a flow chart of an exemplary process performed at a publisher in accordance with a first bid mode, according to an embodiment of the present teaching;

FIG. 15C is a flow chart of an exemplary process performed at an ad exchange engine or an independent advertiser in accordance with a first bid mode, according to an embodiment of the present teaching;

FIG. 16A illustrates an exemplary process between a publisher and an ad exchange engine or an independent advertiser in accordance with a second bid mode, according to an embodiment of the present teaching;

FIG. 16B is a flow chart of an exemplary process performed at a publisher in accordance with a second bid mode, according to an embodiment of the present teaching;

FIG. 16C is a flow chart of an exemplary process performed at an ad exchange engine or an independent advertiser in accordance with a second bid mode, according to an embodiment of the present teaching;

FIG. 17A illustrates an exemplary process between a publisher and an ad exchange engine or an independent advertiser in accordance with a third bid mode, according to an embodiment of the present teaching;

FIG. 17B is a flow chart of an exemplary process performed at a publisher in accordance with a third bid mode, according to an embodiment of the present teaching;

FIG. 17C is a flow chart of an exemplary process performed at an ad exchange engine or an independent advertiser in accordance with a third bid mode, according to an embodiment of the present teaching;

FIG. 18A illustrates an exemplary process between a publisher and an ad exchange engine or an independent advertiser in accordance with a fourth bid mode, according to an embodiment of the present teaching;

FIG. 18B is a flow chart of an exemplary process performed at a publisher in accordance with a fourth bid mode, according to an embodiment of the present teaching;

FIG. 18C is a flow chart of an exemplary process performed at an ad exchange engine or an independent advertiser in accordance with a fourth bid mode, according to an embodiment of the present teaching;

FIG. 19A illustrates an exemplary process between a publisher and an ad exchange engine or an independent advertiser in accordance with a fifth bid mode, according to an embodiment of the present teaching;

FIG. 19B is a flow chart of an exemplary process performed at a publisher in accordance with a fifth bid mode, according to an embodiment of the present teaching;

FIG. 19C is a flow chart of an exemplary process performed at an ad exchange engine or an independent advertiser in accordance with a fifth bid mode, according to an embodiment of the present teaching;

FIG. 20A illustrates an exemplary process between a publisher and an ad exchange engine or an independent advertiser in accordance with a sixth bid mode, according to an embodiment of the present teaching;

FIG. 20B is a flow chart of an exemplary process performed at a publisher in accordance with a sixth bid mode, according to an embodiment of the present teaching;

FIG. 20C is a flow chart of an exemplary process performed at an ad exchange engine or an independent advertiser in accordance with a sixth bid mode, according to an embodiment of the present teaching;

FIG. 21A illustrates an exemplary process between a publisher and an ad exchange engine or an independent advertiser in accordance with a seventh bid mode, according to an embodiment of the present teaching;

FIG. 21B is a flow chart of an exemplary process performed at a publisher in accordance with a seventh bid mode, according to an embodiment of the present teaching;

FIG. 21C is a flow chart of an exemplary process performed at an ad exchange engine or an independent advertiser in accordance with a seventh bid mode, according to an embodiment of the present teaching;

FIG. 22A illustrates an exemplary process between a publisher and an ad exchange engine or an independent advertiser in accordance with a first bid mode, according to an embodiment of the present teaching;

FIG. 22B is a flow chart of an exemplary process performed at a publisher in accordance with a first bid mode, according to an embodiment of the present teaching;

FIG. 22 depicts a general mobile device architecture on which the present teaching can be implemented;

FIG. 23 depicts a general computer architecture on which the present teaching can be implemented; and

FIG. 24 illustrates an exemplary web page where different types of advertisements are presented, according to an embodiment of the present teaching.

### DETAILED DESCRIPTION

Reference will now be made in detail to the embodiments of the present teaching, examples of which are illustrated in the accompanying drawings. While the present teaching will be described in conjunction with the embodiments, it will be understood that they are not intended to limit the present teaching to these embodiments. On the contrary, the present teaching is intended to cover alternatives, modifications, and equivalents, which may be included within the spirit and scope of the present teaching as defined by the appended claims.

In addition, in the following detailed description of embodiments of the present teaching, numerous specific details are set forth in order to provide a thorough understanding of the present teaching. However, it will be recognized by one of ordinary skill in the art that the present teaching may be practiced without these specific details. In other instances, well-known methods, procedures, components, and circuits have not been described in detail as not to unnecessarily obscure aspects of the embodiments of the present teaching.

Various embodiments in accordance with the present teaching provide method and system related to advertisement coordination. More specifically, the method and system in various embodiments of the present teaching are related to coordinating advertisements through online bidding.

A publisher may provide an online service or content, e.g., at a website or a mobile application, to a user. The online service or content may be presented to the user with multiple advertisements in various formats, e.g., a brand advertisement in a fixed position of a web page and a stream advertisement in a content stream at the same web page, where both the advertisements may be presented to the user at (substantially) the same time. Online advertisements may include banner ads, links to web pages, images, video, text, other multimedia formats, etc. Through online bidding, e.g., using a bid request sent by a publisher for two (or more) advertisement opportunities, advertisers are given an option to coordinate or bundle the brand advertisement and the stream advertisement, by, e.g. determining one advertisement based on user's behavior with respect to the other advertisement, generating a single bid regarding both of the advertisements, selecting similar topics or landing pages for the two advertisements, and/or being charged based on an agreement for a combination of the two advertisements. In addition, coordination of the advertisements may also include measuring a return of investment (ROI) for an advertiser based on both the brand advertisement and the stream advertisement submitted by the advertiser and presented with the same online service, e.g., presented on the same web page, via a same (mobile or desktop) application, or in a same user session.

A coordination of advertisements in the present teaching can ensure a consistent user experience with online advertising and further improve ROI for the advertisers. For example, by coordinating different advertisements presented to a same user, the system may give users additional opportunities to reach advertising landing pages (i.e., webpages or websites linked to the advertisement(s) presented to and selected by the user) and can provide advertisers an immediate mechanism to reinforce user brand impression on the same page and/or across multiple pages in the same session.

Additional features will be set forth in part in the description which follows, and in part will become apparent to those skilled in the art upon examination of the following and the accompanying drawings or may be learned by production or operation of the examples.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

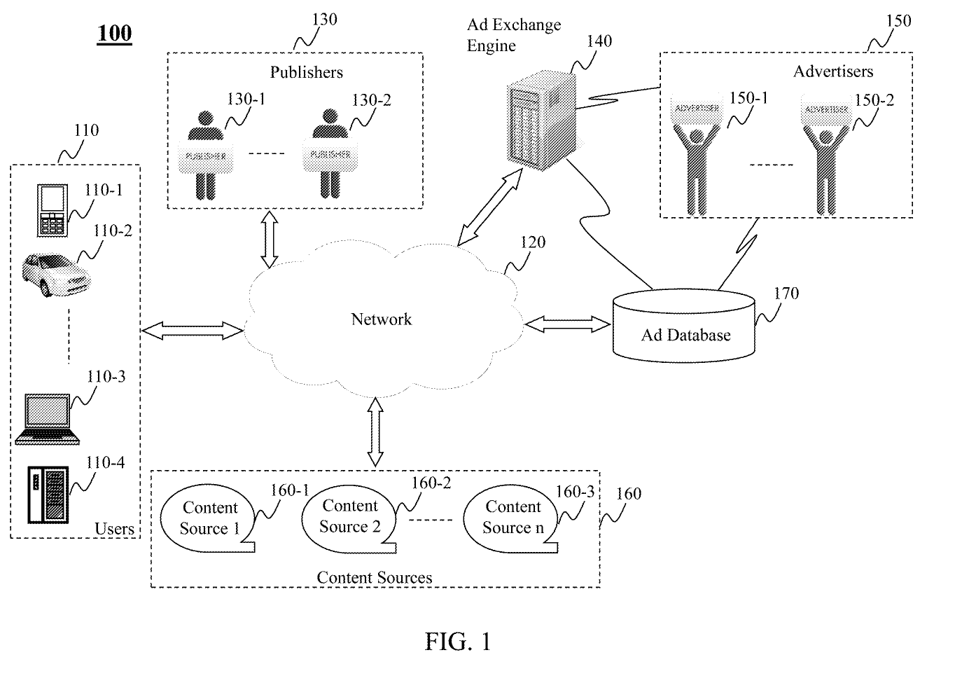

FIG. 1 is a high level depiction of an exemplary networked environment 100 for advertisement coordination through online bidding, according to an embodiment of the present teaching. The exemplary networked environment 100 includes users 110, a network 120, publishers 130, an ad exchange engine 140, advertisers 150, content sources 160, and an ad database 170. The network 120 in networked environment 100 may be a single network or a combination of different networks. For example, a network may be a local area network (LAN), a wide area network (WAN), a public network, a private network, a proprietary network, a Public Telephone Switched Network (PSTN), the Internet, a wireless network, or a virtual network, or any combination thereof. In one embodiment, the network 120 may be an online advertising network or an ad network, which connects advertisers 150 to publishers 130 or websites/mobile applications that want to host advertisements. A key function of an ad network is aggregation of ad-space supply from publishers and matching it with advertiser demand. An ad network may be a television ad network, a print ad network, an online (Internet) ad network, or a mobile ad network.

Users 110 may be of different types such as users connected to the network via desktop connections (110-4), users connecting to the network via wireless connections such as through a laptop (110-3), a handheld mobile device (110-1), or a built-in device in a motor vehicle (110-2). In one embodiment, user(s) 110 may be connected to the network and able to access and interact with online content (provided by the publishers) through wireless technologies and related operating systems implemented within user-wearable devices (e.g., glasses, wrist watch, etc.). A user, e.g., the user 110-1, may send a request for online content to one of the publishers, e.g., 130-1, via the network 120 and receive content through the network 120.

Publishers 130, may correspond to an entity, whether an individual, a firm, or an organization, having publishing business, such as a television station, a newspaper issuer, a web page host, an online service provider, or a game server. For example, in connection to an online or mobile ad network, publishers 130-1 . . . 130-2 can be an organization such as USPTO.gov, a content provider such as CNN.com and Yahoo.com, or a content-feed source such as tweeter or blogs. In one embodiment, publishers 130 include entities that develop, support and/or provide online content via mobile applications (e.g., installed on smartphones, tablet devices, etc.).

Referring to the above example, the content sent to user 110-1 may be generated by the publisher 130-1 based on the content sources 160. A content source may correspond to an entity where the content was originally generated and/or stored. For example, a novel may be originally printed in a magazine, but then posted online at a web site controlled by a publisher. The content sources 160 in the exemplary networked environment 100 include multiple content sources 160-1, 160-2 . . . 160-3.

When content is sent to the user 110-1, one or more advertising opportunities may be available for one or more advertisements to be presented with the content to the user 110-1, on a same web page, via a same application, or in a same user session. For an available advertising opportunity, a bid request may be sent out to advertisers to solicit bids (in monetary terms) with respect to the advertising opportunity. For example, real-time online bidding is usually for selling and buying online display advertising in real time, typically within 100 milliseconds from a user visiting a website. The bid request can be sent out by an ad server (not shown in FIG. 1) that manages the publisher 130-1. The ad server here serves as a supply side platform (SSP) for selling one or more advertisement opportunities by soliciting bids from one or more demand side platforms (DSP) and selecting a winning bid among the bids received from the DSPs. The bid request may be sent out to one or more DSPs.

The ad exchange engine 140 may serve as one DSP for buying one or more advertisement opportunities from an SSP, by running an internal bidding among advertisers 150 and submitting a bid to the SSP, after receiving a bid request from the SSP. An advertiser, e.g. 150-1, may correspond to an entity, whether an individual, a firm, or an organization, doing or planning to do (or otherwise involved in) advertising business. As such, an advertiser 150-1 may be an entity that provides product(s) and/or service(s), and itself handles the advertising process for its own product(s) and/or service(s) at a platform (e.g., websites, mobile applications, etc.) provided by a publisher (i.e., SSP). For example, advertisers 150-1 . . . 150-2 may include companies like General Motors, Best Buy, or Disney. In some other cases, however, an advertiser 150-1 may be an entity that only handles the advertising process for product(s) and/or service(s) provided by another entity.

In one embodiment, the advertisers 150 have stored their advertisements and bidding information at the ad database 170 or at the ad exchange engine 140 that serves as a buyer agent for the advertisers 150. After receiving a bid request for an advertisement opportunity, the ad exchange engine 140 may automatically run an internal online bidding process among the advertisers 150 in real-time based on information stored therein, without actually asking bids from each of the advertisers 150-1 . . . 150-2. After the internal bidding within the ad exchange engine 140 is completed, a bid is selected and sent to the SSP or the corresponding publisher. Referring to the above example, the SSP or the publisher 130-1 may then select a highest bid from bids received from one or more ad exchange engines and provide an advertisement associated with the highest bid along with the content to the user 110-1.

In one example, a plurality of advertisement opportunities is available for presenting a plurality of advertisements in a same user session and/or related to same online content, e.g. a same web page, a same online service, a same online application, or a same online game. In this example, the plurality of advertisements can be selected and optimized in a coordinated manner based on online bidding. In one situation, the publisher 130-1 may send one bid request with respect to the plurality of advertisement opportunities to one or more ad exchange engines to solicit bids. In another situation, the publisher 130-1 may send a first bid request with respect to a first advertisement opportunity of the plurality of advertisement opportunities to one or more ad exchange engines to solicit a first set of bids; and then send a second bid request with respect to a second advertisement opportunity of the plurality of advertisement opportunities to at least one ad exchange engine that is selected based on the first set of bids. In addition, a second advertisement may be determined in accordance with the second advertisement based on a user's past behavior with respect to the first advertisement, if the first advertisement has been presented to the user previously.

The ad database 170 in this embodiment includes advertisements associated with the advertisers 150. The ad database 170 may be connected to the ad exchange engine 140, the advertisers 150, and the network 120. Therefore, after the publisher 130-1 selects a winning bid and determines one or more advertisements associated with the winning bid, the publisher 130-1 may either retrieve the determined advertisements via the ad exchange engine 140 or directly from the ad database 170.

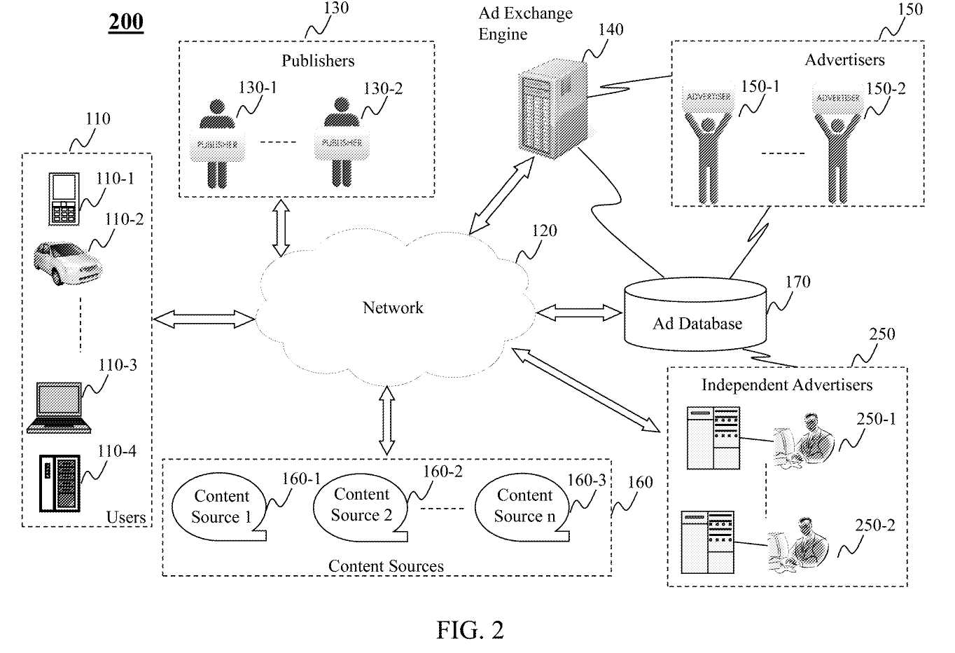

FIG. 2 is a high level depiction of another exemplary networked environment 200 for advertisement coordination through online bidding. In this embodiment, compared to the exemplary networked environment 100, the exemplary networked environment 200 further comprises independent advertisers 250. Each of the independent advertisers 250-1 . . . 250-2 may generate an online bid independently, without help of an ad exchange engine, after receiving a bid request from a publisher via the network 120. An independent advertisers, e.g. 250-1, may correspond to an entity, whether an individual, a firm, or an organization, doing or planning to do (or otherwise involved in) advertising business with its own online bidding functionality. As such, an advertiser 250-1 may be an entity that provides product(s) and/or service(s), and itself handles the advertising process for its own product(s) and/or service(s) in relation with a publisher using its own online bidding functionality. In some other cases, however, an advertiser 150-1 may be an entity that only handles the advertising process using its own online bidding functionality for product(s) and/or service(s) provided by another entity. The independent advertisers 250 may also store their advertisements into the ad database 170 for easy retrieval by a publisher.

In another embodiment, the ad exchange engine 140 may serve as a backend of a publisher 130. For example, a company may serve both as a publisher for providing online advertising and requesting online bidding and as an ad exchange engine for supporting online ad exchange and running online bidding for advertisers.

Various monetization techniques or models may be used in connection with sponsored search advertising, including advertising associated with user search queries, or non-sponsored search advertising, including graphical or display advertising. In an auction-type online advertising marketplace, advertisers may bid in connection with placement of advertisements, although other factors may also be included in determining advertisement selection or ranking. Bids may be associated with amounts advertisers pay for certain specified occurrences, such as for placed or clicked-on advertisements, for example. Advertiser payment for online advertising may be divided between parties including one or more publishers or publisher networks, one or more marketplace facilitators or providers, or potentially among other parties.

Some models may include guaranteed delivery advertising, in which advertisers may pay based at least in part on an agreement guaranteeing or providing some measure of assurance that the advertiser will receive a certain agreed upon amount of suitable advertising, or non-guaranteed delivery advertising, which may include individual serving opportunities or spot market(s), for example. In various models, advertisers may pay based at least in part on any of various metrics associated with advertisement delivery or performance, or associated with measurement or approximation of particular advertiser goal(s). For example, models may include, among other things, payment based at least in part on cost per impression or number of impressions, cost per click or number of clicks, cost per action for some specified action(s), cost per conversion or purchase, or cost based at least in part on some combination of metrics, which may include online or offline metrics, for example.

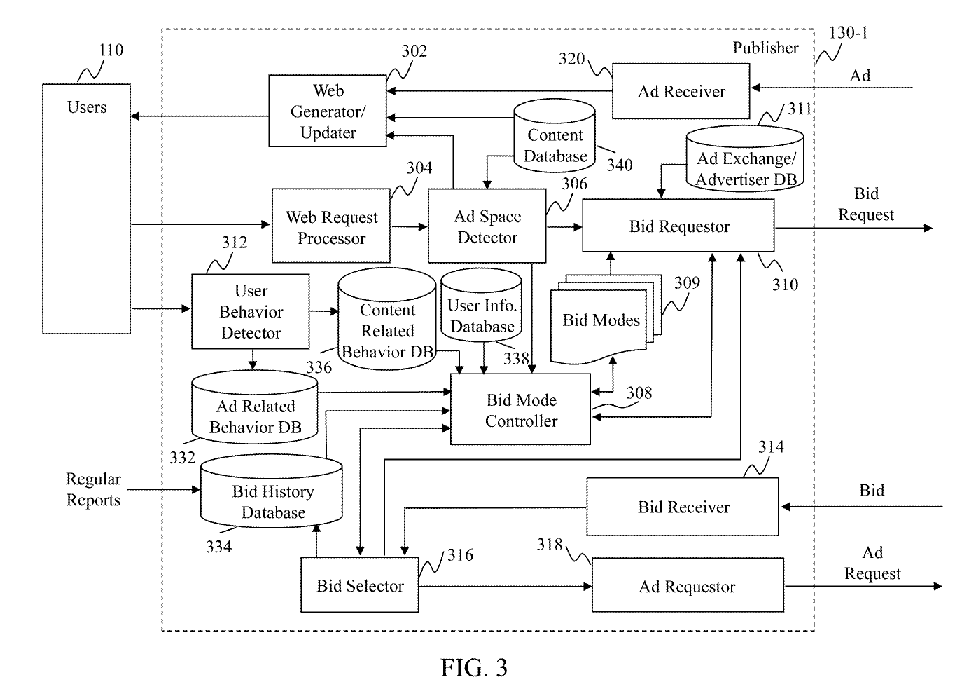

FIG. 3 illustrates an exemplary diagram of a publisher, e.g. the publisher 130-1 as shown in FIG. 1 or FIG. 2, for managing online bidding, according to an embodiment of the present teaching. The publisher 130-1 in this embodiment includes a web generator/updater 302, a web request processor 304, an ad space detector 306, a bid mode controller 308, a bid requestor 310, a user behavior detector 312, a bid receiver 314, a bid selector 316, an ad requestor 318, and an ad receiver 320.

The web request processor 304 is configured to receive and process a web request (or generally, a request for online or Internet-based content) from a user 110, and sending the processed web request to the ad space detector 306. The web request may be related to any form of online (or Internet-based) service that provides one or more online advertisements along with online content to the user 110. In one example, the web request is for a web page, e.g. www.yahoo.com, where different types of advertisements may be presented on the web page to the user 110. In another example, the web request is related to a web application, where application software running in a web browser is rendered to the user 110 with an advertisement. In yet another example, the web request is related to an online game or music or any other application (e.g., installed and accessed on a mobile device as a mobile “app”, e.g., Pandora, etc.), where advertisements may be provided to the user 110 while the online game or music or the application is played or operated by the user 110.

The ad space detector 306 is configured to obtain online content from a content database 340 in the publisher 130-1 based on the web request, detecting advertisement spaces or opportunities related to the online service requested by the user 110 via the web request, and sending information about the advertisement opportunities to the web generator/updater 302, the bid mode controller 308, and the bid requestor 310 and/or other modules of the publisher 130-1. An advertisement opportunity detected by the ad space detector 306 may be related to different types of advertisements, e.g. a display advertisement at a prominent position of an interface of the online service or a stream advertisement fit well in content streams of the online service.

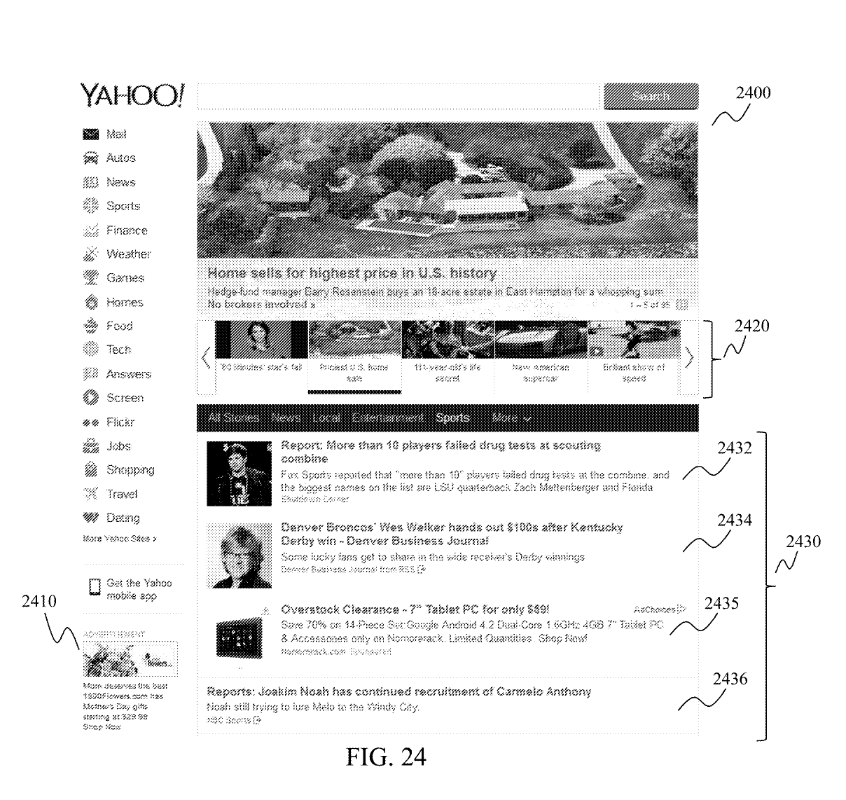

FIG. 24 illustrates an exemplary web page 2400 where different types of advertisements are presented, according to an embodiment of the present teaching. The web page 2400 in this example includes a first content stream 2420 and a second content stream 2430. Outside the content streams 2420 and 2430, a display advertisement 2410 related to a flower delivery business is presented. As shown in FIG. 24, the display advertisement 2410 is located prominently so that it has high value in user branding, i.e., deepening a user's impression about a brand. On the same web page 2400, a stream advertisement 2435 is a kind of native advertisement that is located among the news feeds 2432, 2434, 2436 of the second content stream 2430. The stream advertisement 2435 has the same format as the news 2432, 2434, 2436, and may not be easily distinguished from the news in the same stream. Accordingly, the stream advertisement 2435 may have a much higher click through rate (CTR) compared to the display advertisement 2410. Since the display advertisement 2410 and the stream advertisement 2435 are presented on the same web page 2400, they can be coordinated, e.g. selected and optimized together through an online bidding process.

In one embodiment, some stream advertisement may be included in the first content stream 2420. In another embodiment, the 2400 may be a dynamic web page so that more content and advertisements can be presented when the user scrolls down the web page 2400. Although the different formats of advertisements discussed above relate to a webpage, such description is not limiting. Within the scope of this disclosure, the foregoing and other advertisement formats may be used in conjunction with, e.g., mobile or desktop applications.

For web portals like Yahoo, advertisements may be displayed on web pages resulting from a user-defined search based at least in part upon one or more search terms. Advertising may be beneficial to users, advertisers or web portals if displayed advertisements are relevant to interests of one or more users. Thus, a variety of techniques have been developed to infer user interest, user intent or to subsequently target relevant advertising to users.

One approach to presenting targeted advertisements includes employing demographic characteristics (e.g., age, income, sex, occupation, etc.) for predicting user behavior, such as by group. Advertisements may be presented to users in a targeted audience based at least in part upon predicted user behavior(s).

Another approach includes profile-type ad targeting. In this approach, user profiles specific to a user may be generated to model user behavior, for example, by tracking a user's path through a web site or network of sites, and compiling a profile based at least in part on pages or advertisements ultimately delivered. A correlation may be identified, such as for user purchases, for example. An identified correlation may be used to target potential purchasers by targeting content or advertisements to particular users.

During presentation of advertisements, a presentation system may collect descriptive content about types of advertisements presented to users. A broad range of descriptive content may be gathered, including content specific to an advertising presentation system. Advertising analytics gathered may be transmitted to locations remote to an advertising presentation system for storage or for further evaluation. Where advertising analytics transmittal is not immediately available, gathered advertising analytics may be stored by an advertising presentation system until transmittal of those advertising analytics becomes available.

Back to FIG. 3, the ad space detector 306 may obtain online content based on the web request, where the online content may be used as a basis to determine an online advertisement. In another embodiment, the web request is related to soliciting solely one or more advertisements to be presented to a user in relation to a user application. For example, a user 110 may use a music application implemented or installed on the user's local device, where the application may play (or otherwise process and support) music data stored in the user's local device. In this example, the music application may send a web request to the web request processor 304 via the network 120 for (only) online advertisements to be presented to the user 110 on a user interface associated with the music application. Accordingly, an online service may include solely advertisement(s) obtained online, e.g. through online bidding, without other online content.

In one situation, when the ad space detector 306 does not detect any advertisement space or opportunity based on the web request and/or the content from the content database 340, the web generator/updater 302 may retrieve content from the content database 340 and generate a web page or some other online service based on the retrieved content, without including any advertisement. In this situation, the ad space detector 306 may inform the bid mode controller 308 and the bid requestor 310 that no online bidding is needed.

In another situation, when the ad space detector 306 detects one or more advertisement opportunities based on the web request and/or the content from the content database 340, the web generator/updater 302 may retrieve content from the content database 340, retrieve one or more advertisements from the ad receiver 320, and generate a web page or some other online service based on the retrieved content and the one or more advertisements. In one example, the web generator/updater 302 may wait for the ad receiver 320 to send the one or more advertisements received from an ad exchange engine or an independent advertiser. In this situation, the ad space detector 306 may inform the bid mode controller 308 and the bid requestor 310 that online bidding is needed and send information related to the web request to the bid mode controller 308 and the bid requestor 310.

The user behavior detector 312 may detect user behaviors from a user and analyze the user behaviors. User behaviors related to (user interaction with) content of an online service, e.g. selecting some content, clicking on some content, or typing information related to some content, may be analyzed and stored in a content-related behavior database 336 in the publisher 130-1. User behaviors related to advertisement associated with an online service, e.g. dwelling on an advertisement, clicking on (or otherwise selecting) an advertisement, or skipping an advertisement, may be analyzed and stored in an ad related behavior database 332 in the publisher 130-1.

The publisher 130-1 in this example also includes a user information database 338 and a bid history database 334. The user information database 338 may store user information related to users of the publisher 130-1. User information related to a user may include user identification (ID) of the user, demographic information associated with the user, and/or information related to the user's location, device, web browser, applications used, time-related information with respect to online activities, etc. The bid history database 334 may store historical information related to previous biddings requested by the publisher 130-1. The bid history database 334 may receive regular reports from ad exchange engines, e.g. on a daily basis. A regular report to the publisher 130-1 may include information related to one or more bidding events at an ad exchange engine triggered by bid requests from the publisher 130-1, such as bid requests inducing most number of bids among the advertisers represented by the ad exchange engine, or bid requests inducing least number of bids or no bids among the advertisers represented by the ad exchange engine.

The bid mode controller 308 is configured to retrieve information from the ad related behavior database 332, the bid history database 334, the content related behavior database 336, and the user information database 338, and selecting one or more bid modes from the stored bid modes 309 based on the retrieved information. In the context of this disclosure, a bid mode relates to a manner in which an online bidding process will be performed with respect to one or more detected advertisement opportunities at the ad space detector 306. For example, each of the bid modes 309 relates to different information based on which a bid request for multiple advertisement opportunities is generated, and specific operation(s) and communication(s) between a publisher and an ad exchange (or independent advertiser) conducted to complete the bid request.

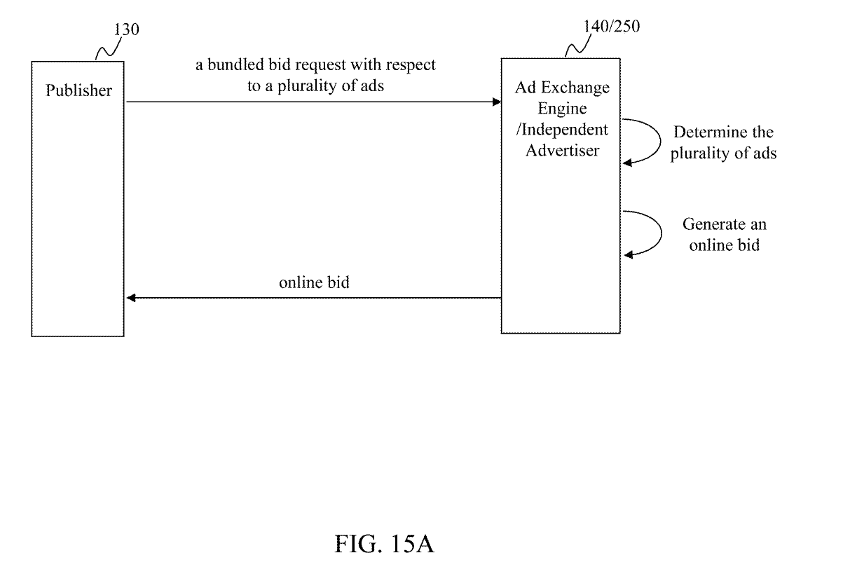

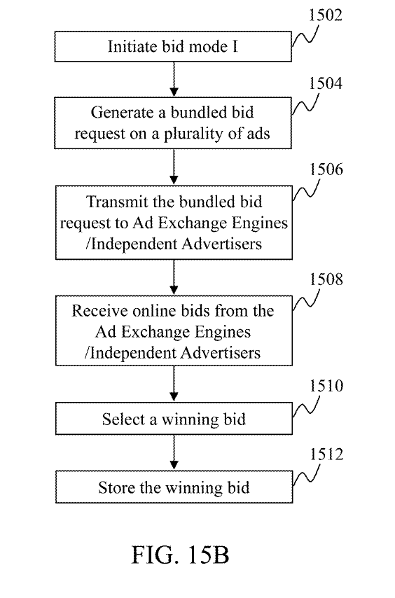

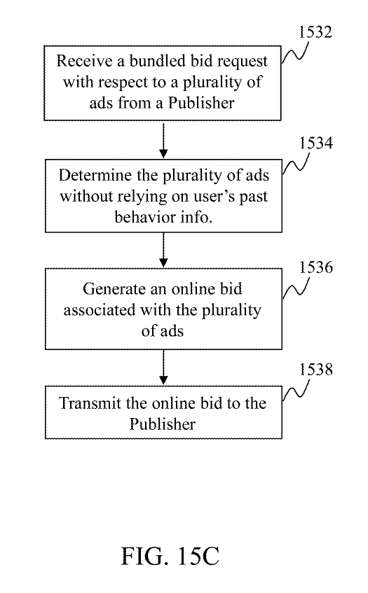

FIGS. 15-21 illustrate seven exemplary processes between a publisher and an ad exchange engine or an independent advertiser in accordance with seven bid modes, according to different embodiments of the present teaching.

Bid Mode I

FIG. 15A illustrates an exemplary process between a publisher 130 and an ad exchange engine 140 or an independent advertiser 250 in accordance with a first bid mode, called bid mode I, according to an embodiment of the present teaching.

As shown in FIG. 15A, in accordance with bid mode I, the publisher 130 sends a bundled bid request with respect to a plurality of advertisement opportunities to one or more online bidders (i.e., a combined, single bid request for multiple advertisement opportunities). An online bidder in this example may be either the ad exchange engine 140 or the independent advertiser 250. The plurality of advertisement opportunities may be related to an online service, by, e.g., located on a same web page, in relation to a same application, or in a same user session. A user session can be defined based on a particular user, a starting time, an ending time, and a session separation mode. A session separation mode may be utilized to determine a starting time and an ending time of a user session of a particular user, based on idle time of the user, similarity of topics the user is accessing or searching, or a predetermined time window, e.g., 10 minutes or 30 minutes.

After receiving the bundled bid request from the publisher 130, an online bidder e.g., the ad exchange engine 140 or the independent advertiser 250, determines a plurality of advertisements in accordance with the plurality of advertisement opportunities. The online bidder may then generate an online bid associated with the plurality of advertisements based on the bundled bid request and transmit the online bid to the publisher 130 as a response to the bundled bid request.

After receiving one or more online bids from the one or more online bidders, the publisher 130 can determine a winning bid from the one or more online bids and identify a plurality of advertisements associated with the winning bid. The identified plurality of advertisements may then be presented to a user, along with the online service. In the context of the present disclosure, an online bid among a plurality of online bids is considered as a “winning bid,” “top bid,” “bundled winning bid,” “ultimate winning bid,” etc., if that online bid promises one of the highest or the highest payment (in monetary terms) for an (individual or bundled) advertisement opportunity. If, however, there is only bid for a particular (individual or bundled) bid request, then that bid is considered as the “winning bid,” “top bid,” “bundled winning bid,” “ultimate winning bid,” etc. Correspondingly, an advertiser or bidder may be considered as a “winning bidder,” top bidder,” etc., if that bidder provided or submitted the “winning bid,” “top bid,” etc.

Bid mode I may be selected when there are multiple advertisement opportunities and most advertisers are determined to prefer a bundled bidding based on bid history. For example, the publisher 130 may collect many bids with high prices in response to a bundled bid request, but may only collect very limited bids with low prices in response to non-bundled bid requests (i.e., bid requests for individual advertisement opportunities). Bid mode I may also be selected when the corresponding user is determined to behave more actively in response to bundled advertisements based on user behavior information, especially regarding the same or similar content of the online service with which the advertisements will be presented to the user. For example, an online music service is to be presented to a user with some advertisements, and the user has historically clicked on many bundled advertisements but has seldom clicked on any non-bundled advertisements, while listening to the music.

FIG. 15B is a flow chart of an exemplary process performed at a publisher, e.g. the publisher 130, in accordance with bid mode I, according to an embodiment of the present teaching. Starting at 1502, the bid mode I is initiated at the publisher 130. At 1504, a bundled bid request with respect to a plurality of advertisement opportunities is generated. The plurality of advertisement opportunities may be related to an online service provided by the publisher 130 to a user. At 1506, the bundled bid request is transmitted to one or more online bidders. Each online bidder in this example may be either an ad exchange engine or an independent advertiser. At 1508, the publisher 130 may receive one or more online bids from the one or more online bidders. Each of the one or more online bids is associated with the plurality of advertisement opportunities. At 1510, a winning bid is determined or selected from the one or more online bids. At 1512, the winning bid is stored at the publisher 130.

It would be understood that, within the context of the teaching of this disclosure, one or more actions may be performed by the publisher 130 after 1512, e.g., identify a plurality of advertisements associated with the winning bid and providing the identified plurality of advertisements to the user, along with the online service. These actions are omitted in FIG. 15B, since they may be performed by the publisher 130 in accordance with other bid modes as well.

FIG. 15C is a flow chart of an exemplary process performed at an ad exchange engine e.g. the ad exchange engine 140 or an independent advertiser e.g. the independent advertiser 250, in accordance with bid mode I, according to an embodiment of the present teaching. Starting at 1532, a bundled bid request with respect to a plurality of advertisement opportunities is received from the publisher 130. At 1534, a plurality of advertisements is determined in accordance with the plurality of advertisement opportunities. At 1536, an online bid associated with the plurality of advertisements is generated. At 1538, the online bid is transmitted to the publisher 130 as a response to the bundled bid request.

Bid Mode II

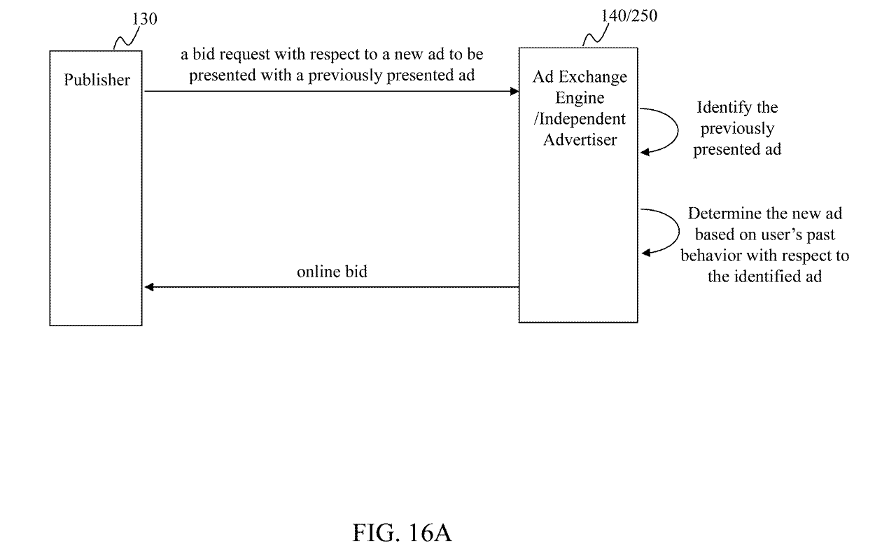

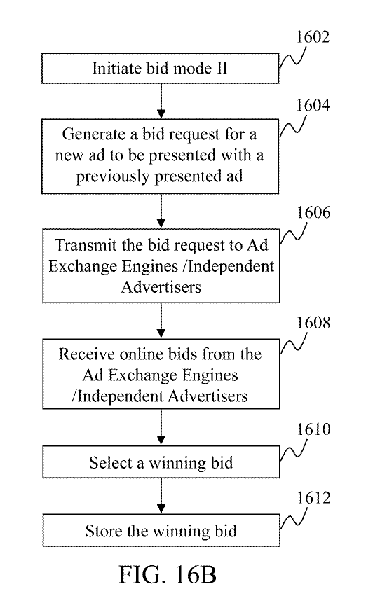

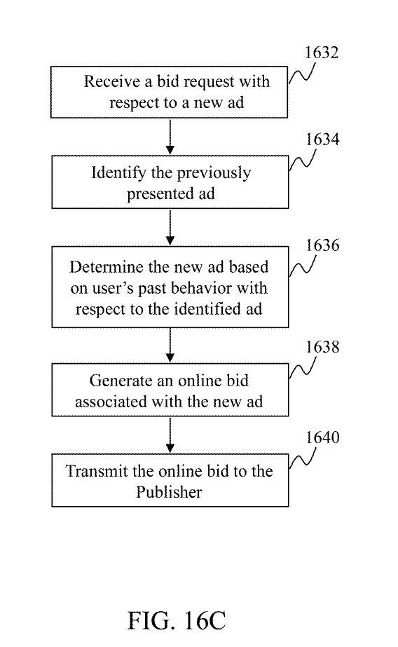

FIG. 16A illustrates an exemplary process between a publisher 130 and an ad exchange engine 140 or an independent advertiser 250 in accordance with a second bid mode, called bid mode II, according to an embodiment of the present teaching.

As shown in FIG. 16A, in accordance with bid mode II, the publisher 130 sends a bid request with respect to an advertisement opportunity to one or more online bidders. An online bidder in this example may be either the ad exchange engine 140 or the independent advertiser 250. The advertisement opportunity may be related to an online service. Bid mode II relates to a situation in which the online service has already been presented to a user with a first advertisement and there is another, a second advertisement opportunity associated with the same online service and the first advertisement. As such, user behavior, based at least on user interaction with the first advertisement, may be used to request a bid and select an advertisement for the second advertisement opportunity. To that end, the bid request sent by the publisher 130 may include user behavior information and other user-related information, in addition to information about the second advertisement opportunity.

After receiving the bid request from the publisher 130, an online bidder, e.g., the ad exchange engine 140 or the independent advertiser 250, obtains the user's behavior information with respect to the first advertisement identified or provided in the bid request, and determines a second advertisement in accordance with the advertisement opportunity based on the user's behavior. The online bidder may then generate an online bid associated with the second advertisement based on the bid request and transmit the online bid to the publisher 130 as a response to the bid request.

After receiving one or more online bids from the one or more online bidders, the publisher 130 may determine a winning bid from the one or more online bids and identify an advertisement associated with the winning bid. The identified second advertisement and the first advertisement may be presented to a user, e.g., such that both of the advertisements are located on a same web page, in relation to a same application, or in a same user session.

Bid mode II may be selected for request a bid when multiple advertisement opportunities are detected for an online service to be provided to a user and one of the opportunities has been determined or reserved for an advertisement that has been previously presented to the user. For example, a user may have already viewed ten brand advertisements via the publisher 130, where the ten advertisements are from ten advertisers. Then after receiving a new request for a web page from the user, if two advertisement spaces/opportunities are detected on the web page, the publisher 130 may reserve one of the two spaces for one of the ten advertisements and send a bid request to the ten advertisers (maybe via an ad exchange engine if some of them are not independent advertisers) for a bid regarding the second of the two spaces. In this example, since the ten advertisers know they can get two spaces on the same web page if they win the bidding, they may tend to bid for the second space with a price higher than what they would bid for an independent or individual ad space available at that publisher. In addition, for each of the ten advertisers, since the user may view again the advertiser's first advertisement at a first space of the web page, the advertiser can determine a second advertisement to be put at the second space of the same web page, based on the user's past behavior with respect to the first advertisement. For example, after a user has viewed a brand advertisement from an advertiser for more than 20 times, the user should have been familiar with the corresponding brand. In that case, there is a good chance for the user to click on a stream advertisement associated with the same corresponding brand, if both the stream advertisement and the brand advertisement are presented on a same web page (e.g., in a same user session) to the user. Therefore, the advertiser may be ready to bid with a relatively higher price for its stream advertisement after its brand advertisement has been viewed enough times, since, in general, a stream advertisement may be more expensive to bid for than a brand advertisement.

FIG. 16B is a flow chart of an exemplary process performed at a publisher, e.g. the publisher 130, in accordance with bid mode II, according to an embodiment of the present teaching. Starting at 1602, the bid mode II is initiated at the publisher 130. At 1604, a bid request with respect to an advertisement opportunity is generated. The advertisement opportunity may be related to an online service provided by the publisher 130 to a user. The online service will be presented to the user with a first advertisement associated with another, a second advertisement opportunity. The first advertisement has been previously presented to the user before. As such, user behavior, based at least on user interaction with the first advertisement, may be used to request a bid and select an advertisement for the second advertisement opportunity.

At 1606, the bid request is transmitted to one or more online bidders. Each online bidder in this example may be either an ad exchange engine or an independent advertiser. At 1608, the publisher 130 may receive one or more online bids from the one or more online bidders. Each of the one or more online bids is associated with the advertisement opportunity. At 1610, a winning bid is determined or selected from the one or more online bids. At 1612, the winning bid is stored at the publisher 130.

It would be understood that, within the context of the teaching of this disclosure, one or more actions may be performed by the publisher 130 after 1612, e.g., identify an advertisement associated with the winning bid and providing the identified advertisement to the user, along with the first advertisement.

FIG. 16C is a flow chart of an exemplary process performed at an ad exchange engine e.g. the ad exchange engine 140 or an independent advertiser e.g. the independent advertiser 250, in accordance with bid mode II, according to an embodiment of the present teaching. Starting at 1632, a bid request with respect to an advertisement opportunity is received from the publisher 130. At 1634, a first advertisement is identified based on the bid request. The advertisement opportunity may be related to an online service provided by the publisher 130 to a user. The online service will be presented to the user with a first advertisement associated with another or a second advertisement opportunity. The first advertisement has been previously presented to the user before. As such, user behavior, based at least on user interaction with the first advertisement, may be used to request a bid and select an advertisement for the second advertisement opportunity.

At 1636, the user's behavior with respect to the first advertisement is obtained and a second advertisement is determined in accordance with the advertisement opportunity based on the user's behavior. At 1638, an online bid associated with the second advertisement is generated. At 1640, the online bid is transmitted to the publisher 130 as a response to the bid request.

Bid Mode III

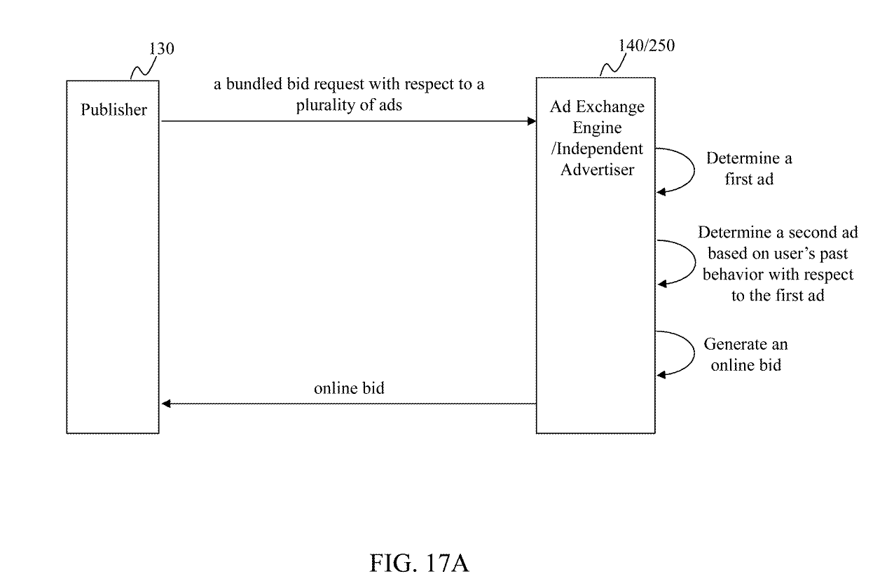

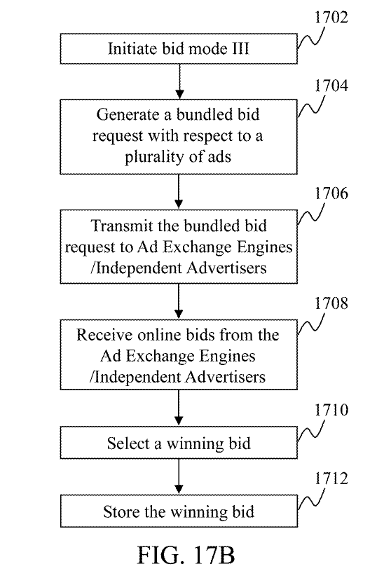

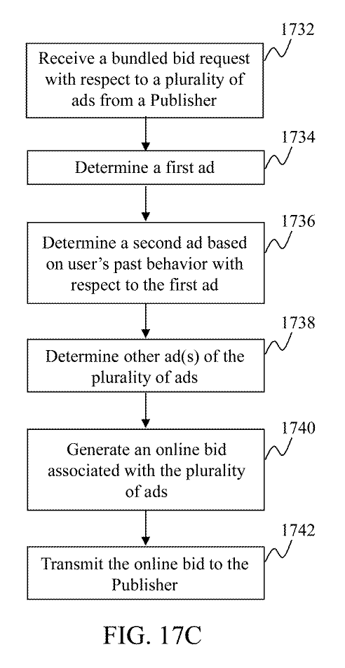

FIG. 17A illustrates an exemplary process between a publisher 130 and an ad exchange engine 140 or an independent advertiser 250 in accordance with a third bid mode, called bid mode III, according to an embodiment of the present teaching.

As shown in FIG. 17A, in accordance with bid mode III, the publisher 130 sends a bundled bid request with respect to a plurality of advertisement opportunities to one or more online bidders. An online bidder in this example may be either the ad exchange engine 140 or the independent advertiser 250. The plurality of advertisement opportunities may be related to an online service, by, e.g., located on a same web page, in relation to a same application, or in a same user session.

After receiving the bundled bid request from the publisher 130, an online bidder e.g. the ad exchange engine 140 or the independent advertiser 250, determines a plurality of advertisements in accordance with the plurality of advertisement opportunities. The plurality of advertisements includes at least a first advertisement that has been previously presented to the user. Therefore, the user may have interacted with the first advertisement, and such user behavior may be used to determine at least a second advertisement of the plurality of advertisements. The online bidder may then generate an online bid associated with the plurality of advertisements based on the bundled bid request and transmit the online bid to the publisher 130 as a response to the bundled bid request.

After receiving one or more online bids from the one or more online bidders, the publisher 130 can determine a winning bid from the one or more online bids and identify a plurality of advertisements associated with the winning bid. The identified plurality of advertisements may be presented to the user, along with the online service.

Bid mode III may be selected when multiple advertisement opportunities are detected for an online service to be provided to a user and most advertisers are determined to prefer a bundled bidding because each of them has at least one advertisement that has been previously presented to the user. For example, based on bid history, the publisher 130 can collect, from advertisers who have at least one advertisement viewed by the user before, many bids with high prices in response to a bundled bid request but can only collect very limited bids with low prices in response to non-bundled bid requests. Bid mode III may also be selected when the corresponding user is determined to behave more actively in response to bundled advertisements including at least one advertisement the user has viewed before, based on user behavior information. In this case, bundled advertisements can help to improve ROI of the advertiser.

FIG. 17B is a flow chart of an exemplary process performed at a publisher, e.g. the publisher 130, in accordance with bid mode III, according to an embodiment of the present teaching. Starting at 1702, the bid mode III is initiated at the publisher 130. At 1704, a bundled bid request with respect to a plurality of advertisement opportunities is generated. The plurality of advertisement opportunities may be related to an online service provided by the publisher 130 to a user. At 1706, the bundled bid request is transmitted to one or more online bidders. Each online bidder in this example may be either an ad exchange engine or an independent advertiser. At 1708, the publisher 130 may receive one or more online bids from the one or more online bidders. Each of the one or more online bids is associated with the plurality of advertisement opportunities. At 1710, a winning bid is determined or selected from the one or more online bids. At 1712, the winning bid is stored at the publisher 130.

It would be understood that, within the context of the teaching of this disclosure, one or more actions may be performed by the publisher 130 after 1712, e.g., identify a plurality of advertisements associated with the winning bid and providing the identified plurality of advertisements to the user, along with the online service.

FIG. 17C is a flow chart of an exemplary process performed at an ad exchange engine e.g. the ad exchange engine 140 or an independent advertiser e.g. the independent advertiser 250, in accordance with bid mode III, according to an embodiment of the present teaching. Starting at 1732, a bundled bid request with respect to a plurality of advertisement opportunities is received from the publisher 130. At 1734, a first advertisement is determined in accordance with one of the plurality of advertisement opportunities. The first advertisement has been previously presented to the user. At 1736, a second advertisement is determined based on the user's past behavior with respect to the first advertisement. At 1738, other advertisements, if there are any, of the plurality of advertisements are determined. At 1740, an online bid associated with the plurality of advertisements is generated. At 1742, the online bid is transmitted to the publisher 130 as a response to the bundled bid request.

Bid Mode IV

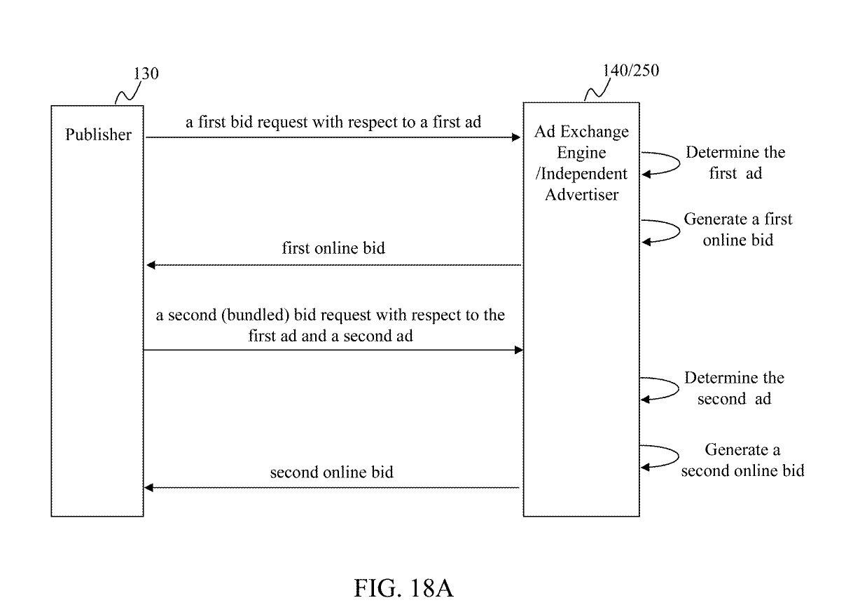

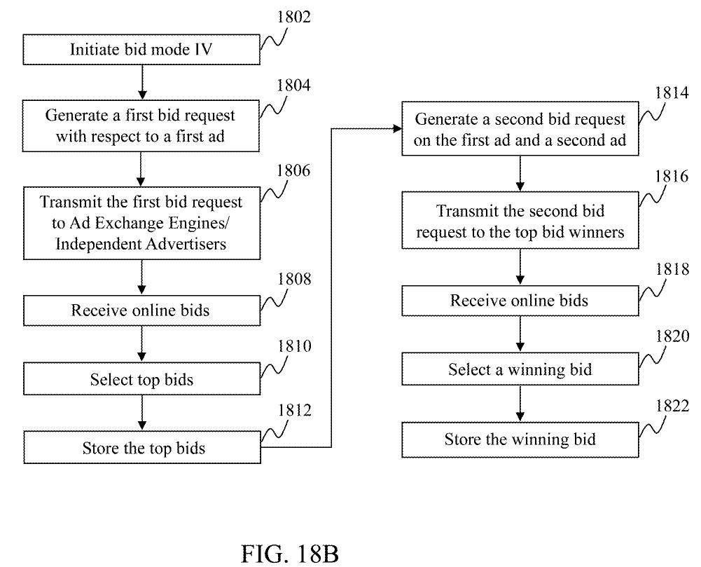

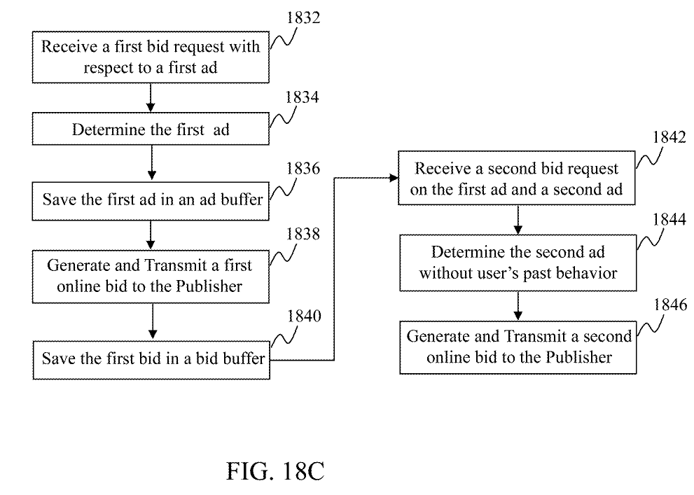

FIG. 18A illustrates an exemplary process between a publisher 130 and an ad exchange engine 140 or an independent advertiser 250 in accordance with a fourth bid mode, called bid mode IV, according to an embodiment of the present teaching.

As shown in FIG. 18A, in accordance with bid mode IV, the publisher 130 sends a first bid request with respect to a first advertisement opportunity to one or more online bidders. An online bidder in this example may be either the ad exchange engine 140 or the independent advertiser 250.

After receiving the first bid request from the publisher 130, an online bidder, e.g., the ad exchange engine 140 or the independent advertiser 250, determines a first advertisement in accordance with the first advertisement opportunity. The online bidder may then generate a first online bid associated with the first advertisement based on the first bid request and transmit the first online bid to the publisher 130 as a response to the first bid request.

After receiving one or more online bids from the one or more online bidders, the publisher 130 can determine one or more winning bids from the one or more online bids and identify one or more online winning bidders from the one or more online bidders that submitted the corresponding winning bid. The publisher 130 may then generate and send a second bid request to the online winning bidder(s). The second bid request may be a bundled bid request with respect to both the first advertisement opportunity and a second advertisement opportunity. Both the first and second advertisement opportunities are related to an online service to be provided by the publisher 130 to a user. The first and second advertisement opportunities may be located on a same web page, in relation to a same application, or in a same user session.

After receiving the second bid request (which is bundled for both the first and second advertisement opportunities) from the publisher 130, an online winning bidder, e.g., the ad exchange engine 140 or the independent advertiser 250, determines a second advertisement in accordance with the second advertisement opportunity. The online winning bidder may then generate a second online bid associated with both the first and second advertisements based on the second bid request and transmit the second online bid to the publisher 130 as a response to the second bid request.

After receiving the second online bids from the online winning bidders, the publisher 130 may determine a bundled winning bid from the second online bids, and identify two advertisements associated with the bundled winning bid. The identified two advertisements may be presented to the user, along with the online service.

Bid mode IV may be selected when multiple advertisement opportunities are detected for an online service to be provided to a user and a portion of the advertisers are determined to prefer a bundled bidding based on bid history. For example, based on bid history, the publisher 130 may collect or receive bundled bids with relatively higher prices from one set of advertisers; and the publisher 130 may collect non-bundled bids with relatively higher prices from another set of advertisers. In accordance with bid mode IV, the publisher 130 may first determine a subset of available advertisers/bidders who have bid a “good” price for an individual first advertisement opportunity (e.g., a price above a certain known threshold), seek another bid from those subset of bidders for a bundle of the first advertisement and a new second advertisement opportunity, and then determine the ultimate winning bidder from the subset of bidders for the bundled advertisement opportunities

FIG. 18B is a flow chart of an exemplary process performed at a publisher, e.g., the publisher 130, in accordance with bid mode IV, according to an embodiment of the present teaching. Starting at 1802, the bid mode IV is initiated at the publisher 130. At 1804, a first bid request with respect to a first advertisement opportunity is generated. At 1806, the first bid request is transmitted to one or more online bidders. Each online bidder in this example may be either an ad exchange engine or an independent advertiser. At 1808, the publisher 130 may receive one or more online bids from the one or more online bidders. Each of the one or more online bids is associated with the first advertisement opportunity. At 1810, one or more top bids are selected from the one or more online bids, and corresponding one or more top bidders from the one or more online bidders are identified. At 1812, the one or more top bids are stored at the publisher 130.

At 1814, a second bid request bundled for both the first advertisement opportunity and a second advertisement opportunity is generated. Both the first and second advertisement opportunities are related to an online service to be provided by the publisher 130 to a user. At 1816, the second bid request is transmitted to the one or more top bidders. At 1818, responsive to the second bid request, the publisher 130 may receive one or more second online bids from the one or more top bidders. Each of the one or more second online bids is associated with both the first and second advertisement opportunities. At 1820, a bundled winning bid is determined or selected from the one or more second online bids. At 1822, the bundled winning bid is stored at the publisher 130.

It would be understood that, within the context of the teaching of this disclosure, one or more actions may be performed by the publisher 130 after 1822, e.g., identify two advertisements associated with the winning bid and providing the identified two advertisements to the user, along with the online service.

FIG. 18C is a flow chart of an exemplary process performed at an ad exchange engine, e.g., the ad exchange engine 140 or an independent advertiser e.g. the independent advertiser 250, in accordance with bid mode IV, according to an embodiment of the present teaching. Starting at 1832, a first bid request with respect to a first advertisement opportunity is received from the publisher 130. At 1834, a first advertisement is determined in accordance with the first advertisement opportunity. At 1836, the first advertisement is saved in an ad buffer in the ad exchange engine 140 or the independent advertiser 250. At 1838, a first online bid associated with the first advertisement is generated and transmitted to the publisher 130 as a response to the first bid request. At 1840, the first online bid is saved in a bid buffer in the ad exchange engine 140 or the independent advertiser 250.

At 1842, a second bid request bundled for both the first advertisement opportunity and a second advertisement opportunity is received from the publisher 130. Both the first and second advertisement opportunities are related to an online service to be provided by the publisher 130 to a user. At 1844, a second advertisement is determined in accordance with the second advertisement opportunity. At 1846, a second bundled online bid associated with the first and second advertisements is generated, and transmitted to the publisher 130 as a response to the second bid request.

Bid Mode V

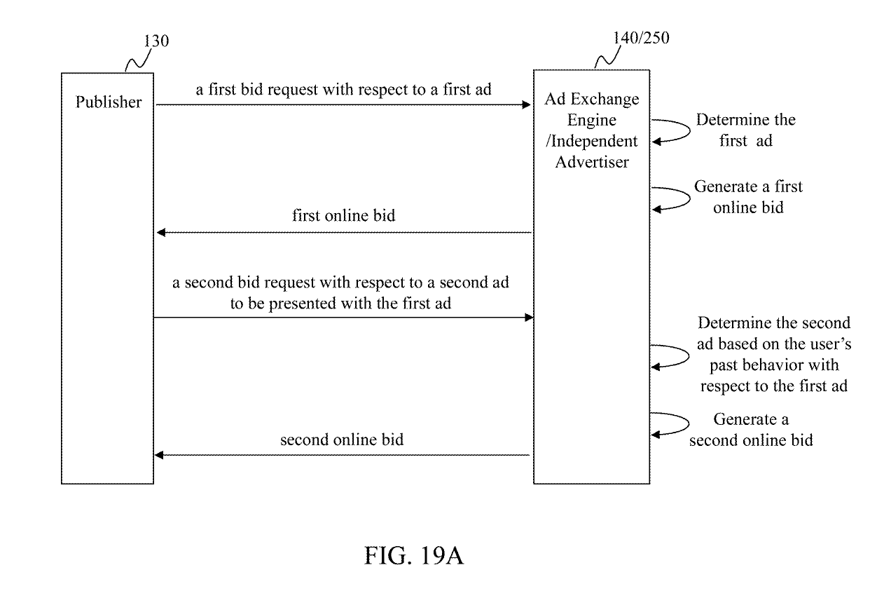

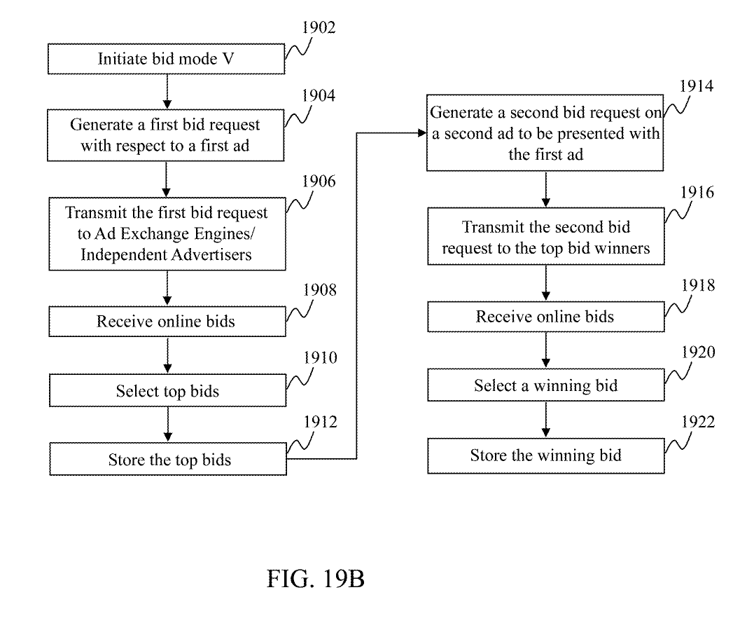

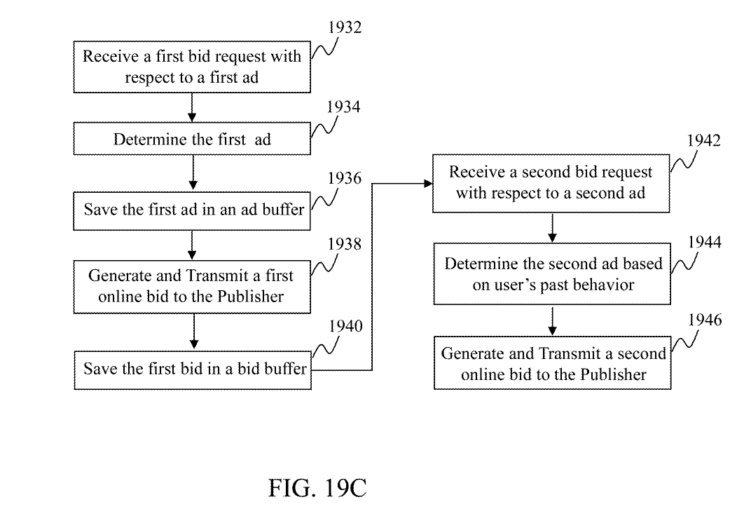

FIG. 19A illustrates an exemplary process between a publisher 130 and an ad exchange engine 140 or an independent advertiser 250 in accordance with a fifth bid mode, called bid mode V, according to an embodiment of the present teaching.

As shown in FIG. 19A, in accordance with bid mode V, the publisher 130 sends a first bid request with respect to a first advertisement opportunity to one or more online bidders. An online bidder in this example may be either the ad exchange engine 140 or the independent advertiser 250.

After receiving the first bid request from the publisher 130, an online bidder, e.g., the ad exchange engine 140 or the independent advertiser 250, determines a first advertisement in accordance with the first advertisement opportunity. The online bidder may then generate a first online bid associated with the first advertisement based on the first bid request, and transmit the first online bid to the publisher 130 as a response to the first bid request.

After receiving one or more online bids from the one or more online bidders, the publisher 130 may determine one or more winning bids from the one or more online bids, and identify corresponding one or more online winning bidders from the one or more online bidders. The publisher 130 may then generate and send a second bid request with respect to a second advertisement opportunity to the one or more online winning bidders. Both the first and second advertisement opportunities are related to an online service to be provided by the publisher 130 to a user. The first and second advertisement opportunities may be located on a same web page, in relation to a same application, or in a same user session.

After receiving the second bid request from the publisher 130, each online winning bidder, e.g., the ad exchange engine 140 or the independent advertiser 250, determines a second advertisement in accordance with the second advertisement opportunity. The second advertisement may be determined based on at least the user's behavior/interaction with respect to the first advertisement. The online winning bidder may then generate a second online bid associated with the second advertisement based on the second bid request and transmit the second online bid to the publisher 130 as a response to the second bid request.

After receiving the second online bid(s) from the one or more online winning bidders, the publisher 130 may determine a second winning bid from the second online bid(s), identify an ultimate winning bidder associated with the second winning bid, and identify two advertisements associated with two online bids (i.e., the winning bid for the first advertisement opportunity and the second winning bid for the second advertisement opportunity) submitted by the ultimate winning bidder. The identified two advertisements may be presented to the user, along with the online service.

Bid mode V may be selected when multiple advertisement opportunities are detected for an online service to be provided to a user, and most advertisers are determined to prefer a non-bundled bidding based on bid history, although each of them has at least one advertisement that has been previously presented to the user. For example, based on bid history, the publisher 130 may collect bids with relatively higher prices for non-bundled bid requests than a bundled bid request from most advertisers. In accordance with bid mode V, the publisher 130 may first determine a subset of advertisers/bidders who bid a “good” price for a first advertisement opportunity (e.g., a price higher than a certain known threshold), seek another bid from those subset of bidders for a second advertisement opportunity, and then determine the winning bidder from the subset of bidders for the second advertisement opportunity. The second advertisement is determined based on the user's past behavior with respect to the first advertisement.

FIG. 19B is a flow chart of an exemplary process performed at a publisher, e.g., the publisher 130, in accordance with bid mode V, according to an embodiment of the present teaching. Starting at 1902, the bid mode V is initiated at the publisher 130. At 1904, a first bid request with respect to a first advertisement opportunity is generated. At 1906, the first bid request is transmitted to one or more online bidders. Each online bidder in this example may be either an ad exchange engine or an independent advertiser. At 1908, the publisher 130 may receive one or more online bids from the one or more online bidders. Each of the one or more online bids is associated with the first advertisement opportunity. At 1910, one or more top bids are selected from the one or more online bids, and corresponding one or more top bidders from the one or more online bidders are identified. At 1912, the one or more top bids are stored at the publisher 130.

At 1914, a second bid request with respect to a second advertisement opportunity is generated. Both the first and second advertisement opportunities are related to a same online service to be provided by the publisher 130 to a user (e.g., in a same user session). At 1916, the second bid request is transmitted to the one or more top bidders. At 1918, the publisher 130 may receive one or more second online bids from the one or more top bidders. Each second online bid is associated with the second advertisement opportunity. At 1920, a second winning bid is determined or selected from the second online bid(s). At 1922, the second winning bid is stored at the publisher 130.

It would be understood that, within the context of the teaching of this disclosure, one or more actions may be performed by the publisher 130 after 1922, e.g., determining a winning bidder associated with the winning bid, identifying two advertisements associated with two online bids submitted by the winning bidder, and providing the identified two advertisements to the user, along with the online service.

FIG. 19C is a flow chart of an exemplary process performed at an ad exchange engine, e.g., the ad exchange engine 140 or an independent advertiser e.g. the independent advertiser 250, in accordance with bid mode V, according to an embodiment of the present teaching. Starting at 1932, a first bid request with respect to a first advertisement opportunity is received from the publisher 130. At 1934, a first advertisement is determined in accordance with the first advertisement opportunity. At 1936, the first advertisement is saved in an ad buffer in the ad exchange engine 140 or the independent advertiser 250. At 1938, a first online bid associated with the first advertisement is generated and transmitted to the publisher 130 as a response to the first bid request. At 1940, the first online bid is saved in a bid buffer in the ad exchange engine 140 or the independent advertiser 250.

At 1942, a second bid request with respect to a second advertisement opportunity is received from the publisher 130. Both the first and second advertisement opportunities are related to a same online service to be provided by the publisher 130 to a user. At 1944, a second advertisement is determined in accordance with the second advertisement opportunity, based on the user's behavior with respect to the first advertisement. At 1946, a second online bid associated with the second advertisement is generated and transmitted to the publisher 130 as a response to the second bid request.

Bid Mode VI

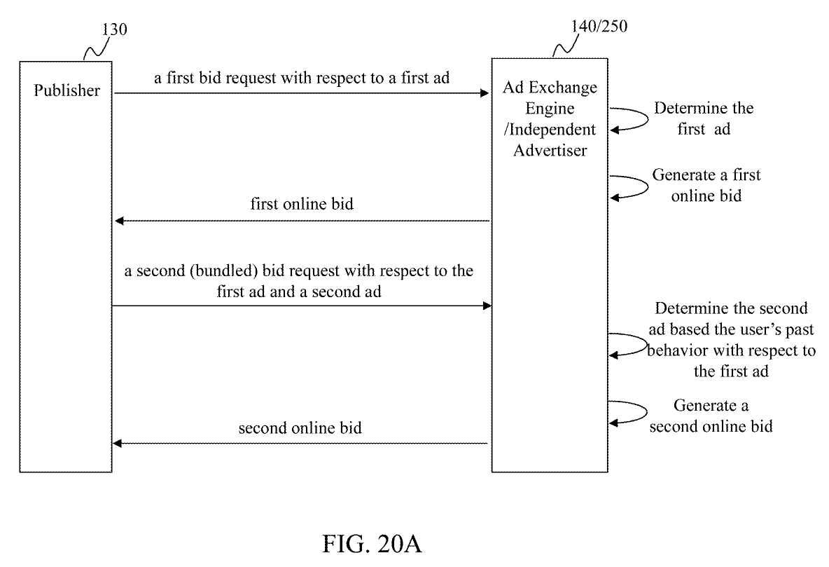

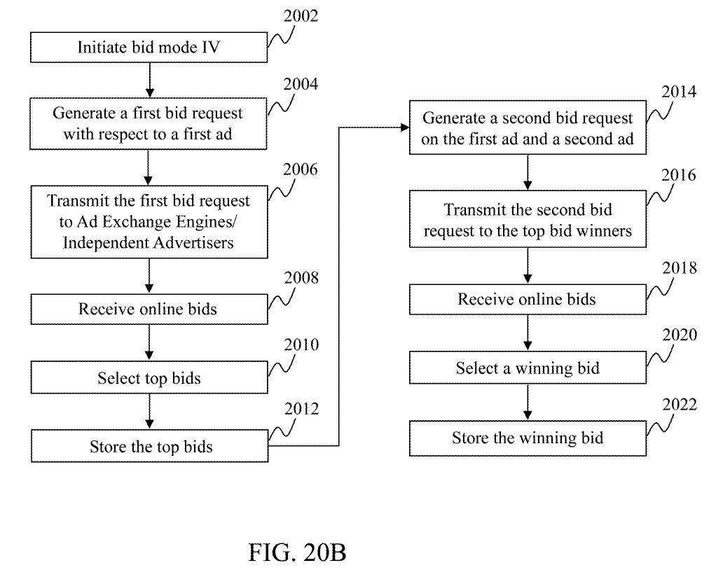

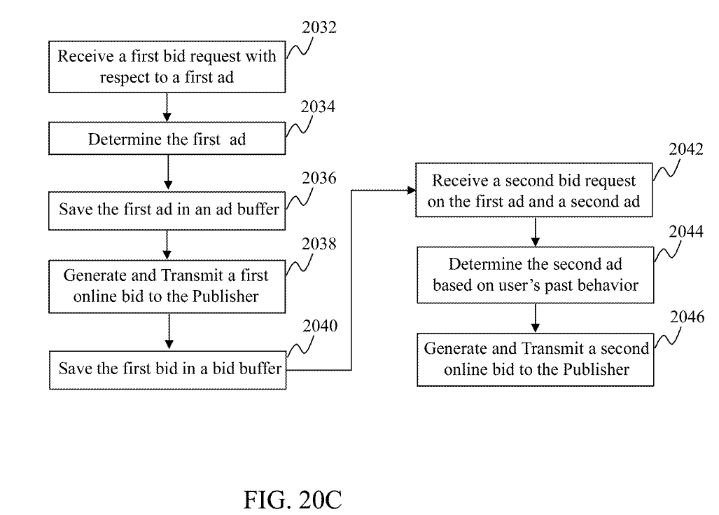

FIG. 20A illustrates an exemplary process between a publisher 130 and an ad exchange engine 140 or an independent advertiser 250 in accordance with a sixth bid mode, called bid mode VI, according to an embodiment of the present teaching.

As shown in FIG. 20A, in accordance with bid mode VI, the publisher 130 sends a first bid request with respect to a first advertisement opportunity to one or more online bidders. An online bidder in this example may be either the ad exchange engine 140 or the independent advertiser 250.

After receiving the first bid request from the publisher 130, an online bidder, e.g., the ad exchange engine 140 or the independent advertiser 250, determines a first advertisement in accordance with the first advertisement opportunity. The online bidder may then generate a first online bid associated with the first advertisement based on the first bid request and transmit the first online bid to the publisher 130 as a response to the first bid request.

After receiving one or more first online bids for the first bid request from the one or more online bidders, the publisher 130 may determine one or more winning bids from the one or more first online bids and identify corresponding one or more winning bidders from the one or more online bidders. The publisher 130 may then generate and send a second bid request to the one or more winning bidders. The second bid request may be a bundled bid request for both the first advertisement opportunity and a second advertisement opportunity. Both the first and second advertisement opportunities are related to a same online service to be provided by the publisher 130 to a user, by e.g., being located on a same web page, in relation to a same application, or in a same user session.

After receiving the second bid request from the publisher 130, each winning bidder, e.g., the ad exchange engine 140 or the independent advertiser 250, determines a second advertisement in accordance with the second advertisement opportunity, e.g., based at least on the user's behavior with respect to the first advertisement. The winning bidder may then generate a second online bid associated with both the first and second advertisements based on the second bid request and transmit the second online bid to the publisher 130 as a response to the second bid request.

After receiving one or more second online bids for the second bid request from the one or more winning bidders, the publisher 130 can determine a bundled winning bid from the second online bid(s), and identify two advertisements associated with the bundled winning bid. The identified two advertisements may be presented to the user, along with the online service.

Bid mode VI may be selected when multiple advertisement opportunities are detected for an online service to be provided to a user and a portion of the advertisers are determined to prefer a bundled bidding based on bid history, while most advertisers have at least one advertisement that has been previously presented to the user. For example, based on bid history, the publisher 130 may receive relatively higher bids (in monetary terms) for bundled bid requests from some advertisers, while receive relatively higher bids for non-bundled bid requests from other advertisers. In accordance with bid mode VI, the publisher 130 may first determine a subset of advertisers/bidders who bid a “good” price for a first advertisement opportunity (e.g., a price higher than a certain known threshold), seek another bid from those subset of bidders for a bundle of the first advertisement and a new second advertisement opportunity, and then determine the ultimate winning bidder from the subset of bidders for the bundled advertisement opportunities. The bundled advertisements include the first advertisement previously provided by the ultimate winning bidder to the user and a second advertisement that is determined based on the user's past behavior with respect to the first advertisement.

FIG. 20B is a flow chart of an exemplary process performed at a publisher, e.g., the publisher 130, in accordance with bid mode VI, according to an embodiment of the present teaching. Starting at 2002, the bid mode VI is initiated at the publisher 130. At 2004, a first bid request with respect to a first advertisement opportunity is generated. At 2006, the first bid request is transmitted to one or more online bidders. Each online bidder in this example may be either an ad exchange engine or an independent advertiser. At 2008, the publisher 130 may receive one or more online bids from the one or more online bidders. Each of the one or more online bids is associated with the first advertisement opportunity. At 2010, one or more top bids are selected from the one or more online bids (e.g., based on a certain bid price threshold), and corresponding one or more top bidders from the one or more online bidders are identified. At 2012, the one or more top bids are stored at the publisher 130.

At 2014, a second bid request bundled for both the first advertisement opportunity and a second advertisement opportunity is generated. Both the first and second advertisement opportunities are related to an online service to be provided by the publisher 130 to a user. At 2016, the second bid request is transmitted to the top bidder(s). At 2018, the publisher 130 may receive one or more bundled online bids from the top bidder(s). Each bundled online bid is associated with both the first and second advertisement opportunities. At 2020, a bundled winning bid is determined or selected from the bundled online bids. At 2022, the bundled winning bid is stored at the publisher 130.

It would be understood that, within the context of the teaching of this disclosure, one or more actions may be performed by the publisher 130 after 2022, e.g., identify two advertisements associated with the winning bid and providing the identified two advertisements to the user, along with the online service.

FIG. 20C is a flow chart of an exemplary process performed at an ad exchange engine, e.g., the ad exchange engine 140 or an independent advertiser, e.g., the independent advertiser 250, in accordance with bid mode VI, according to an embodiment of the present teaching. Starting at 2032, a first bid request with respect to a first advertisement opportunity is received from the publisher 130. At 2034, a first advertisement is determined in accordance with the first advertisement opportunity. At 2036, the first advertisement is saved in an ad buffer in the ad exchange engine 140 or the independent advertiser 250. At 2038, a first online bid associated with the first advertisement is generated and transmitted to the publisher 130 as a response to the first bid request. At 2040, the first online bid is saved in a bid buffer in the ad exchange engine 140 or the independent advertiser 250.

At 2042, a second bid request with respect to both the first advertisement opportunity and a second advertisement opportunity is received from the publisher 130. Both the first and second advertisement opportunities are related to an online service to be provided by the publisher 130 to a user. At 2044, a second advertisement is determined in accordance with the second advertisement opportunity, based on the user's behavior with respect to the first advertisement. At 2046, a second online bid associated with the first and second advertisements is generated and transmitted to the publisher 130 as a response to the second bid request.

Bid Mode VII

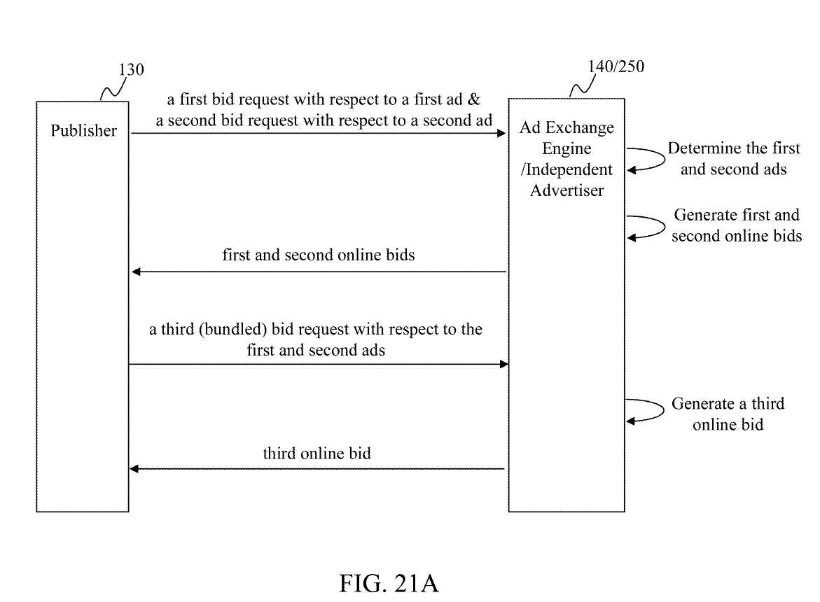

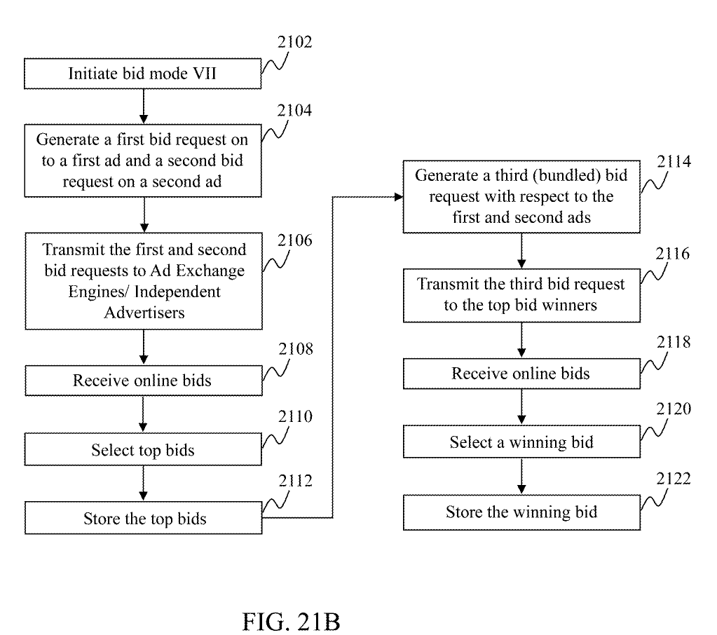

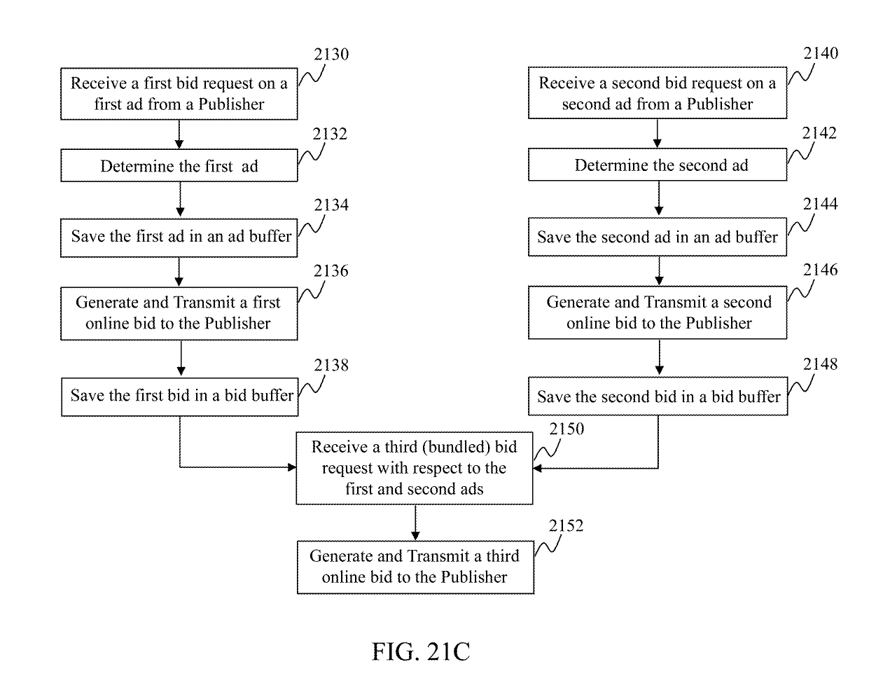

FIG. 21A illustrates an exemplary process between a publisher 130 and an ad exchange engine 140 or an independent advertiser 250 in accordance with a seventh bid mode, called bid mode VII, according to an embodiment of the present teaching.

As shown in FIG. 21A, in accordance with bid mode VII, the publisher 130 sends a first bid request with respect to a first advertisement opportunity and a second (independent) bid request with respect to a second advertisement opportunity to one or more online bidders. An online bidder in this example may be either the ad exchange engine 140 or the independent advertiser 250.

After receiving the first and second bid requests from the publisher 130, an online bidder, e.g., the ad exchange engine 140 or the independent advertiser 250, determines a first advertisement in accordance with the first advertisement opportunity and a second advertisement in accordance with the second advertisement opportunity. The online bidder may generate a first online bid associated with the first advertisement and second online bid associated with the second advertisement, and transmit the first and second online bids to the publisher 130 as a response to the first and second bid requests, respectively.

After receiving one or more online bids from the one or more online bidders, the publisher 130 may determine one or more winning bids from the one or more online bids and identify corresponding one or more winning bidders from the one or more online bidders. Each of the one or more online bids is associated with either the first advertisement opportunity or the second advertisement opportunity. The publisher 130 may then generate and send a third bid request to the winning bidder(s). The third bid request may be a bundled bid request with respect to both the first and second advertisement opportunities. Both the first and second advertisement opportunities are related to an online service to be provided by the publisher 130 to a user. The first and second advertisement opportunities may be located on a same web page, in relation to a same application, or in a same user session.

After receiving the third bid request from the publisher 130, each winning bidder, e.g., the ad exchange engine 140 or the independent advertiser 250, generates a third online bid associated with both the first and second advertisements based on the third bid request and transmit the third online bid to the publisher 130 as a response to the third bid request.

After receiving the third online bid(s) from the winning bidder(s), the publisher 130 may determine a bundled winning bid from the third online bid(s) and identify two advertisements associated with the bundled winning bid. The identified two advertisements may be presented to the user, along with the online service.

Bid mode VII may be selected when multiple advertisement opportunities are detected for an online service to be provided to a user and it may not be determined whether the advertisers prefer a bundled bidding based on bid history. For example, the publisher 130 may have seldom sent out a bundled bid request before and may be satisfied with independent bidding for individual advertisement opportunities so far. In accordance with bid mode VII, the publisher 130 may first determine a subset of advertisers/bidders who have bid a “good” price (e.g., a price higher than a certain known threshold) for a first advertisement opportunity and/or a second advertisement opportunity. In one example, none of the received bids may be considered as “good”. In another example, there may be two bidders who have submitted a same total bid price for two advertisement opportunities: e.g., the first bidder bid $5 for the first advertisement opportunity and $10 for the second advertisement opportunity, while the second bidder bid $10 for the first advertisement opportunity and $5 for the second advertisement opportunity. To increase a chance for the user to click the advertisement(s) and thus improve ROI for advertisers, the publisher 130 may decide to select one winning bidder from the two bidders for the two advertisement opportunities. Thus, the publisher 130 may send a third bundled bid request to both of the two bidders for another round of bidding regarding the total price of the two advertisement opportunities. The third bid request may include information that the two advertisements will be presented to the user on a same web page, in relation to a same application, or in a same user session. The final bundled winning bidder (out of the two original bidders) may then be determined based on the third bundled bids, in accordance with bid mode VII.

FIG. 21B is a flow chart of an exemplary process performed at a publisher, e.g., the publisher 130, in accordance with bid mode VII, according to an embodiment of the present teaching. Starting at 2102, the bid mode VII is initiated at the publisher 130. At 2104, a first bid request with respect to a first advertisement opportunity and a second bid request with respect to a second advertisement opportunity are generated. At 2106, the first and second bid requests are transmitted to one or more online bidders. Each online bidder in this example may be either an ad exchange engine or an independent advertiser. At 2108, the publisher 130 may receive one or more online bids from the one or more online bidders. Each of the one or more online bids is associated with either the first or the second advertisement opportunity. At 2110, one or more top bids are selected from the one or more online bids (e.g., based on a certain bid price threshold), and corresponding one or more top bidders from the one or more online bidders are identified. At 2112, the one or more top bids are stored at the publisher 130.

At 2114, a third bid request bundled for both the first and second advertisement opportunities is generated. Both the first and second advertisement opportunities are related to an online service to be provided by the publisher 130 to a user. At 2116, the third bid request is transmitted to the one or more top bidders. At 2118, the publisher 130 may receive bundled bid(s) from the top bidder(s). Each bundled bid is associated with both the first and second advertisement opportunities. At 2120, a bundled winning bid is determined or selected from the bundled bids received from the top bidder(s). At 2122, the bundled winning bid is stored at the publisher 130.

It would be understood that, within the context of the teaching of this disclosure, one or more actions may be performed by the publisher 130 after 2122, e.g., identify two advertisements associated with the winning bid and providing the identified two advertisements to the user, along with the online service.

FIG. 21C is a flow chart of an exemplary process performed at an ad exchange engine, e.g., the ad exchange engine 140 or an independent advertiser, e.g., the independent advertiser 250, in accordance with bid mode VII, according to an embodiment of the present teaching. Starting at 2130, a first bid request with respect to a first advertisement opportunity is received from the publisher 130. At 2132, a first advertisement is determined in accordance with the first advertisement opportunity. At 2134, the first advertisement is saved in an ad buffer in the ad exchange engine 140 or the independent advertiser 250. At 2136, a first online bid associated with the first advertisement is generated and transmitted to the publisher 130 as a response to the first bid request. At 2138, the first online bid is saved in a bid buffer in the ad exchange engine 140 or the independent advertiser 250. At 2140, a second bid request with respect to a second advertisement opportunity is received from the publisher 130. At 2142, a second advertisement is determined in accordance with the second advertisement opportunity. At 2144, the second advertisement is saved in the ad buffer in the ad exchange engine 140 or the independent advertiser 250. At 2146, a second online bid associated with the second advertisement is generated and transmitted to the publisher 130 as a response to the second bid request. At 2148, the second online bid is saved in the bid buffer in the ad exchange engine 140 or the independent advertiser 250. The actions of 2130-2138 and the actions of 2140-2148 may be performed in parallel as shown in FIG. 21C or in sequence according to other embodiments.

At 2150, a third bid request with respect to both the first and second advertisement opportunities is received from the publisher 130. Both the first and second advertisement opportunities are related to an online service to be provided by the publisher 130 to a user. At 2152, a third online bid associated with the first and second advertisements is generated and transmitted to the publisher 130 as a response to the third bid request.

It would be understood that other bid modes may be applied in accordance with various embodiments of the present teaching. For example, a conventional bid mode may be used where the advertisements are not bundled for bidding, one advertisement is not determined based on another, and there is no coordination between advertisements even if they are on a same web page at the same time.

Referring back to FIG. 3, the bid mode controller 308 may select a bid mode based on: user information of a user to whom the advertisements will be presented, content related behavior of the user, ad related behavior of the user, and/or bid history information related to the user, the bid mode, or the content to be presented to the user. In one example, bid mode I may be selected when there are multiple advertisement opportunities and most advertisers are determined to prefer a bundled bidding based on bid history. In another example, bid mode V may be selected when multiple advertisement opportunities are detected for an online service to be provided to a user and most advertisers are determined to prefer a non-bundled bidding based on bid history, but where the advertisers have at least one advertisement which has already been presented to the user and with which user behavior is available.

In accordance with one embodiment, a bid mode is selected based on some user information, if, e.g., there has been a correlation between user's age and user's preference of a bid mode in history. In accordance with another embodiment, a bid mode is selected based on information about the detected advertisement spaces or opportunities, and user's content related behavior. For example, when multiple advertisement spaces are detected on a web page related to sports and the user has only clicked on (or selected) bundled advertisements on a sport related web page, a bid mode related to a bundled bid request may be chosen for the bidding process. After a bid mode from the various bid modes is selected, the bid mode controller 308 may send the selected bid mode to the bid requestor 310 for generating a bid request, and to the bid selector 316 for selecting one or more winning bids in accordance with the selected bid mode.

The bid requestor 310 is configured to generate a bid request based on the selected bid mode and sending the bid request to one or more online bidders. The bid requestor 310 may retrieve information from an ad exchange/advertiser database 311 in the publisher 130-1 to determine ad exchange engines or independent advertisers to whom a bid request should be sent. In one situation, the bid request is a first bid request in accordance with bid mode I, as shown in FIG. 15A. In that case, the bid requestor 310 may retrieve information from the ad exchange/advertiser database 311 and determine online bidders to whom a bid request should be sent, based on, e.g., a match between the topic of the online service and topics of interest of the online bidders, a match between the selected bid mode and preferred bid mode(s) of online bidders. In another situation, the bid request is a second bid request in accordance with bid mode IV, as shown in FIG. 18A. In that case, the bid requestor 310 may retrieve information from the bid selector 316 and send a bid request to the online bidders selected or determined by the bid selector 316.

The bid receiver 314 is configured to receive online bids from online bidders. The bid selector 316 is configured to select one or more winning bids from the received online bids, in accordance with different bid modes. For example, in accordance with bid mode IV, the bid selector 316 selects multiple top online bids for the first round of bidding, and selects one bundled winning bid for the second round of bidding. After the first round, the bid selector 316 may also inform the bid requestor 310 about multiple top bidders to whom the bid requestor 310 should send a bid request during the second bidding round. Thus, the bid selector 316 may communicate with the bid mode controller 308 to determine a bid mode for selecting winning bid(s) from received bids. The bid selector 316 may also store information related to the winning bid(s) into the bid history database 334.

After a winning bid is determined, the ad requestor 318 may send an ad request for one or more advertisements associated with the winning bid. In one example, the ad request is sent to a winning bidder who has submitted the winning bid. In one example, the ad request is sent directly to the ad database 170 for advertisement retrieval.

The ad receiver 320 is configured for receiving the one or more advertisements requested by the ad requestor 318, and sending the one or more advertisements to the web generator/updater 302 for generating or updating an online service, e.g., a web page, a music application, or a game service. In one embodiment, the web generator/updater 302 may keep updating the web page 2400 shown in FIG. 24, by providing new content and/or new advertisements when the user scrolls down the web page 2400.

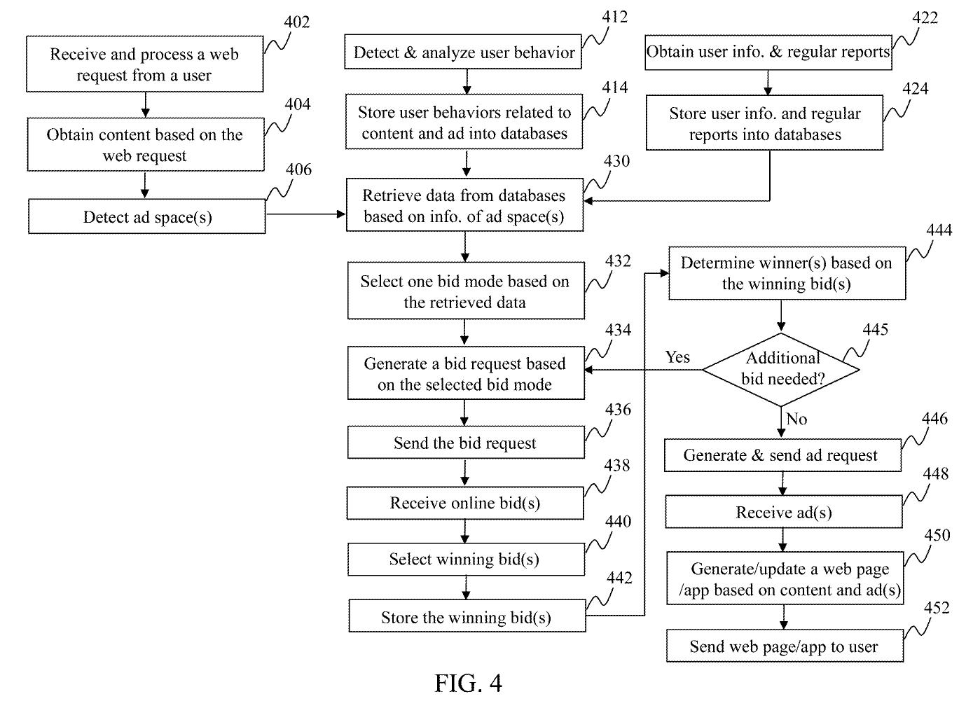

FIG. 4 is a flow chart of an exemplary process for managing online bidding, in accordance with one embodiment of the present teaching. In one example, the exemplary process is performed by the publisher 130-1 in FIG. 3. Starting at 402, a web request is received from a user and processed. The web request may be for an online service, e.g., a web page, an application, a game, a music service, or a search result. At 404, content is obtained based on the web request. At 406, one or more advertisement spaces or opportunities are detected associated with the web request. The process may then proceed to 430.

At 412, user behavior is detected and analyzed. At 414, user behavior related to content and advertisements are stored into the content related behavior database 336 and the ad related behavior database 332, respectively. The process may then proceed to 430.

At 422, information about the user and regular reports about historical bidding are obtained. At 424, the obtained user information and regular reports are stored into the user information database 338 and the bid history database 334, respectively. The process may then proceed to 430.

It would be understood that, the three sub-processes 402-406, 412-414, and 422-424, may be performed in parallel, as shown in FIG. 4, or in serial according to other embodiments.

Proceeding to 430, information or data are retrieved from different databases, e.g., the ad related behavior database 332, the bid history database 334, the content related behavior database 336, and/or the user information database 338. At 432, a bid mode is selected based on the retrieved data. At 434, a bid request is generated based on the selected bid mode. For example, if the selected bid mode is bid mode I, a bundled bid request with respect to a plurality of advertisement opportunities is generated. At 436, the bid request is sent to one or more online bidders. An online bidder in this example may be either the ad exchange engine 140 or the independent advertiser 250. At 438, one or more online bids are received from the one or more online bidders. Then, at least one winning bid is selected at 440 from the one or more online bids, and stored at 442 into a database, e.g., the bid history database 334. At 444, at least one winner, i.e. winning bidder, is determined or identified based on the at least one winning bid.

At 445, it is determined whether an additional bid is needed. If yes, the process goes back to 434 for generating another bid request based on the selected bid mode. This may happen after a first round of bidding in accordance with bid mode IV, as shown in FIG. 18A, where more bids are needed for a second round of bidding. Otherwise, if no additional bid is needed, at 446, an ad request is generated and sent out. In this situation, one winning bid and one winning bidder are determined. In one example, the ad request is sent to the winning bidder for advertisement retrieval. In another example, the ad request is sent directly to the ad database 170 for advertisement retrieval, where the ad request includes information about an advertisement ID associated with the winning bid.

At 448, one or more advertisements are received in response to the ad request. At 450, an online service is generated or updated based on the obtained content and/or the received advertisements, in accordance with the web request. The online service may be a web page, an application, a game, a music service, or a search result. At 452, the online service is sent to the user in response to the web request.

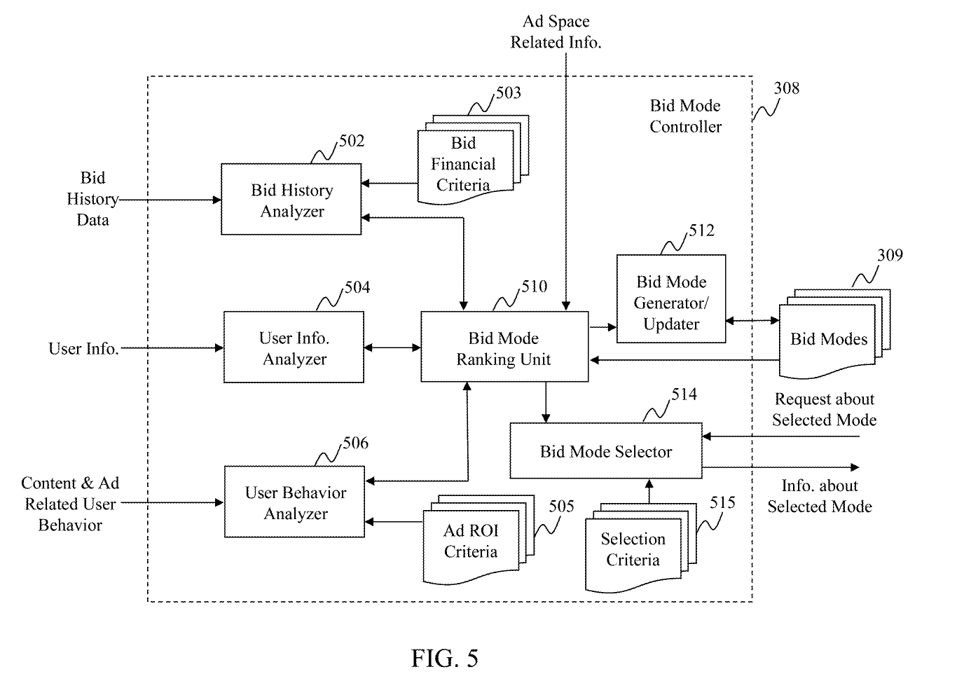

FIG. 5 illustrates an exemplary diagram of a bid mode controller 308 in a publisher, e.g. the publisher 130-1, according to an embodiment of the present teaching. The bid mode controller 308 in this example includes a bid history analyzer 502, a user information analyzer 504, a user behavior analyzer 506, a bid mode ranking unit 510, a bid mode generator/updater 512, and a bid mode selector 514.

The bid mode ranking unit 510 in this example receives information related to advertisement space or opportunity, from the ad space detector 306. The information may be associated with an online service to be provided to a user, and include information about: e.g. user ID of the user, content of the online service, location or format of the advertisement opportunity associated with the online service. The bid mode ranking unit 510 may retrieve bid modes 309 and rank the bid modes based on analyzed information obtained from the bid history analyzer 502, the user information analyzer 504, and the user behavior analyzer 506. The bid mode ranking unit 510 may send a request to the bid history analyzer 502, the user information analyzer 504, or the user behavior analyzer 506 for desirable information based on the information related to advertisement opportunity, e.g., user ID of the user, content of the online service, location or format of the advertisement opportunity associated with the online service. The bid mode ranking unit 510 may also pass information obtained from one of the analyzers 502, 504, 506 to another.

The bid history analyzer 502 is configured to receive and analyze bid history data from the bid history database 334. The bid history data may be analyzed based on one or more bid financial criteria 503 stored in the bid mode controller 308. In one example, the bid history analyzer 502 may determine, according to each bid mode, a percentage of historical bids that have bid prices higher than a threshold, and are for advertisements associated with the content of the online service.

The user information analyzer 504 is configured to receive and analyze user information from the user information database 338. The user information may be analyzed based on user ID of the user who sent the web request. In one example, the user information analyzer 504 may determine the user's age, sex, location, or device information.

The user behavior analyzer 506 is configured to receive and analyze content related user behavior from the content related behavior database 336 and ad related user behavior from the ad related behavior database 332. The user behavior information may be analyzed based on one or more ad ROI criteria 505 stored in the bid mode controller 308. In one example, a ROI for an advertiser may be measured based on a ratio of a profit coming from its advertisement to the cost of the advertisement. In another example, a ROI for an advertiser may be measured based on a ratio of a positive response from a user regarding its advertisement to the cost of the advertisement. The positive user response may include clicking on or otherwise selecting the advertisement, dwelling on the advertisement, browsing or buying products related to the advertisement, and putting a related product into a shopping cart and/or other user interactions with the advertisement.

In one embodiment, the user behavior analyzer 506 may determine, according to each bid mode, a ROI for the winning advertiser whose advertisement has been selected or interacted with by a user. The ROI may be determined based on, e.g., user ID of the user, content of the online service, location or format of the advertisement opportunity associated with the online service, and/or topic of the advertisements of the winning advertiser.

After collecting information from the bid history analyzer 502, the user information analyzer 504, and the user behavior analyzer 506, the bid mode ranking unit 510 may determine a ranking list for the bid modes 309, based on one or more factors. For example, a ranking score for a bid mode can be determined based a percentage of historical bids having bid prices higher than a threshold according to the bid mode. A ranking score for a bid mode may also be determined based on bid prices of the historical winning bids according to the bid mode. A ranking score for a bid mode may also be determined based on ROIs for the winning advertisers, according to the bid mode. A ranking score for a bid mode may also be determined based on an average (or any other statistical value) of ROIs for the winning advertisers whose advertisements have been reacted by users having similar age, sex, location, or device information compared to the user sending the web request, according to the bid mode.

A ranking list may be generated based on a ranking score for each bid mode. In one embodiment, the bid mode ranking unit 510 may consider multiple factors together and generate one ranking list of the bid modes based on each of the multiple factors with a weight. In another embodiment, the bid mode ranking unit 510 may generate multiple ranking lists of the bid modes, where each ranking list is generated based on a different factor.

In one example, the bid mode ranking unit 510 may send a request to the bid mode generator/updater 512 for generating a new bid mode, e.g., when none of the existing bid modes can achieve a high ranking score. In another example, the bid mode ranking unit 510 may send a request to the bid mode generator/updater 512 for updating an existing bid mode, e.g., when the existing bid mode always achieves a low ranking score. The bid mode generator/updater 512 may retrieve one or more bid modes according to the request from the bid mode ranking unit 510, generate or update the retrieved one or more bid modes, and store them back into the database 309.

The bid mode selector 514 may receive the one or more ranking lists from the bid mode ranking unit 510 and select a bid mode. When the bid mode selector 514 receives one ranking list of the bid modes from the bid mode ranking unit 510, the bid mode selector 514 may determine a bid mode based on the ranking list and some selection criteria 515 stored in the bid mode controller 308. For example, when the top three bid modes of a ranking list have very close ranking scores, the bid mode selector 514 may either select the bid mode with highest rank based on one criterion, or select the bid mode that has been used most or least frequently based on another criterion. When the bid mode selector 514 receives multiple ranking lists of the bid modes from the bid mode ranking unit 510, the bid mode selector 514 may first select one of the multiple ranking lists based on a criterion, and then select a bid mode based on the selected ranking list.

The bid mode selector 514 may receive a request about selected mode, e.g. from the bid requestor 310 or the bid selector 316. In response to the request, the bid mode selector 514 may send some information about the selected mode to the bid requestor 310 or the bid selector 316.

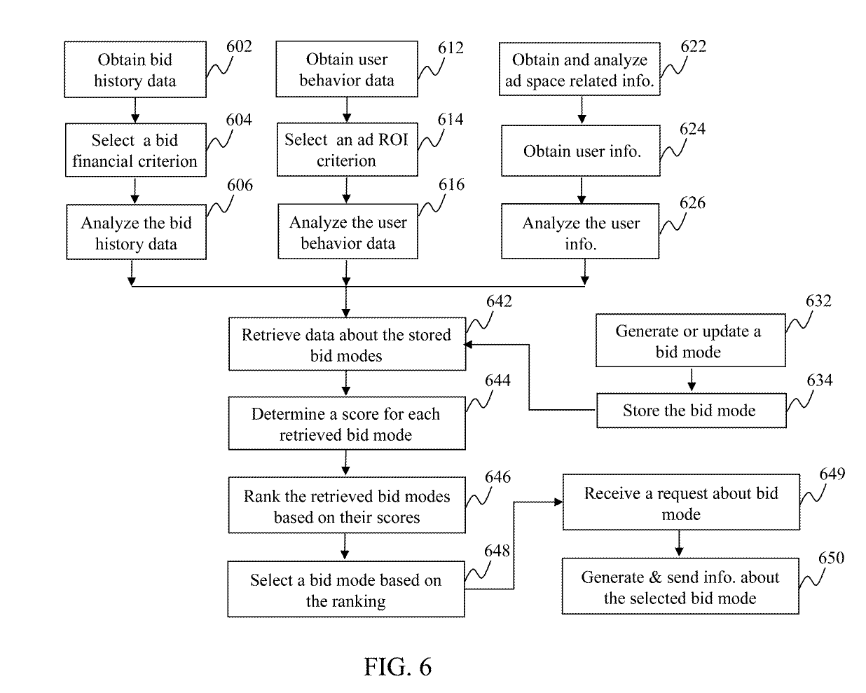

FIG. 6 is a flow chart of an exemplary process performed at a bid mode controller, e.g. the bid mode controller 308 in FIG. 5, according to an embodiment of the present teaching. Starting at 602, information or data related to bid history is obtained. At 604, a bid financial criterion is selected. At 606, the information or data related to bid history is analyzed based on the selected bid financial criterion. The process may then proceed to 642.

At 612, information or data related to user behavior is obtained. At 614, an ad ROI criterion is selected. At 616, the user behavior data is analyzed based on the selected ad ROI criterion. The process may then proceed to 642.

At 622, information related to detected advertisement space or opportunity is obtained. The information may include user ID of the user sending a web request. At 624, user information about the user is obtained based on the user ID. In one embodiment, more information about other users who have similar user information compared to the user is also obtained at 624. At 626, the user information is analyzed. The process may then proceed to 642.

It would be understood that, the three sub-processes 602-606, 612-614, and 622-626, may be performed in parallel, as shown in FIG. 6, or in serial according to other embodiments.

At 642, data about the stored bid modes are retrieved. At 644, a ranking score is determined for each retrieved bid mode, based on, e.g., at least one of the analyzed information at 606, 616, and 626. At 646, the retrieved bid modes are ranked based on their ranking scores to generate a ranking list. At 648, a bid mode is selected based on the ranking list, according to one or more criteria. Optionally at 649, a request is received about the selected bid mode. At 650, information about the selected bid mode is generated and sent, e.g. in response to the request.

Optionally at 632, a bid mode may be generated or updated. At 634, the bid mode is stored for future use and the process goes to 642.

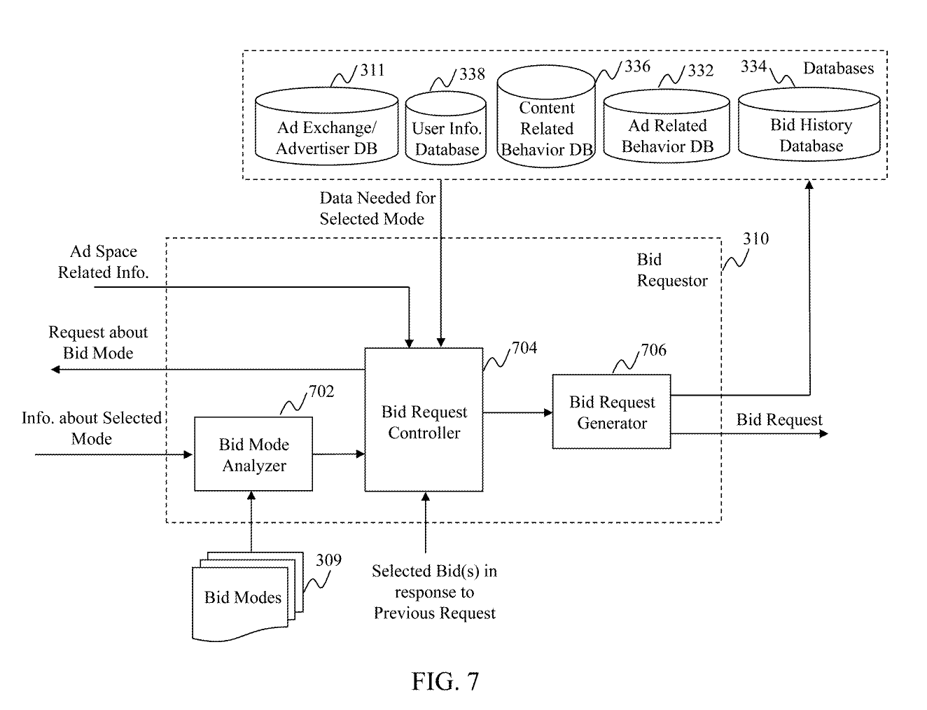

FIG. 7 illustrates an exemplary diagram of a bid requestor 310 in a publisher, e.g., the publisher 130-1, according to an embodiment of the present teaching. The bid requestor 310 in this example includes a bid mode analyzer 702, a bid request controller 704, and a bid request generator 706. The bid mode analyzer 702 is configured to receive and analyze information about the selected bid mode from the bid mode controller 308. In one example, the information about the selected bid mode is received in response to a request about bid mode sent by the bid request controller 704. The information about the selected bid mode may include an index of the selected bid mode and/or a ranking score of the selected bid mode indicating a confidence level for selecting the bid mode. The bid mode analyzer 702 may retrieve data about the selected bid mode based on its index, from the bid mode database 309, and send the data to the bid request controller 704.

The bid request controller 704 may receive ad space related information, i.e., information about detected advertisement space or opportunity from the ad space detector 306. In one example, after obtaining one or more ad spaces detected on a web page to be presented to a user, the bid request controller 704 may proactively send a request about bid mode to the bid mode controller 308, as described above.

After the bid request controller 704 receives data about the selected bid mode, the bid request controller 704 may retrieve data needed for the selected bid mode from one or more databases including, e.g., the ad exchange/advertiser database 311, the user information database 338, the content related behavior database 336, the bid history database 334, and the ad related behavior database 332. According to one embodiment, these databases are cross-indexed so that they may be able to exchange information to each other. In one example, when bid mode I is selected, the bid requestor 310 may retrieve information from the ad exchange/advertiser database 311 and determine online bidders to send a bid request to, based on, e.g., a match between the topic of a web page where the ad spaces are detected and topics of interest for the online bidders. In another example, when bid mode II is selected, the bid requestor 310 may retrieve information from the ad exchange/advertiser database 311 and determine online bidders who preferred bid mode II based on the retrieved information.

In yet another example, bid mode IV may be selected, and the bid requestor 310 may already have sent out a first bid request to some online bidders, as illustrated in FIG. 18A. The bid request controller 704 may then receive one or more selected bids from the bid selector 316. The selected bids were based on online bids in response to a previous bid request, i.e., the first bid request in this example. The bid request controller 704 may determine one or more online bidders based on the one or more selected bids, so that a second bid request, in accordance with bid mode IV, is generated and sent to the one or more online bidders. In accordance with another embodiment, the one or more online bidders may be determined by the bid selector 316 and the bid request controller 704 may perform a further screen on the online bidders, based on related information from the databases shown in FIG. 7.

The bid request generator 706 may generate a bid request according to an instruction from the bid request controller 704. The instruction may include information about the bid mode, the content of the online service, the location or format of the ad space, etc. The above mentioned information may be associated with the bid request and sent out with the bid request. The instruction may also include the targets, i.e., one or more online bidders, to send the bid request to. The bid request generator 706 may send the generated bid request to the targets according to the instruction from the bid request controller 704. In one example, the bid request generator 706 may save the bid request to the bid history database 334.

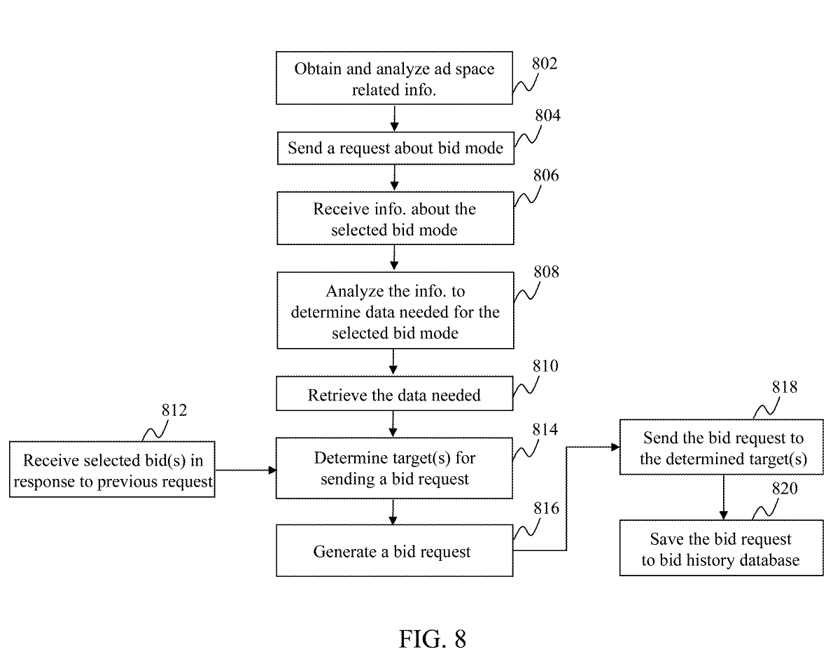

FIG. 8 is a flow chart of an exemplary process performed at a bid requestor, e.g. the bid requestor 310 in FIG. 7, according to an embodiment of the present teaching. Starting at 802, information about detected ad space or opportunity is obtained and analyzed. Optionally at 804, a request about bid mode is sent, e.g. to the bid mode controller 308. At 806, information about the selected bid mode is received. At 808, the about the selected bid mode is analyzed to determine data needed in accordance with the selected bid mode. At 810, the data needed is retrieved from one or more databases. At 812, one or more selected bids in response to a previous request are received.

In one embodiment, at 814, targets for sending a bid request, e.g., one or more online bidders, are determined based on the retrieved data at 810. In another embodiment, at 814, targets for sending a bid request, e.g. one or more online bidders, are determined based on the retrieved data at 810 and the one or more selected bids received at 812.

At 816, a bid request is generated accordingly. At 818, the bid request is sent to the determined targets. At 820, the bid request is saved into the bid history database 334.

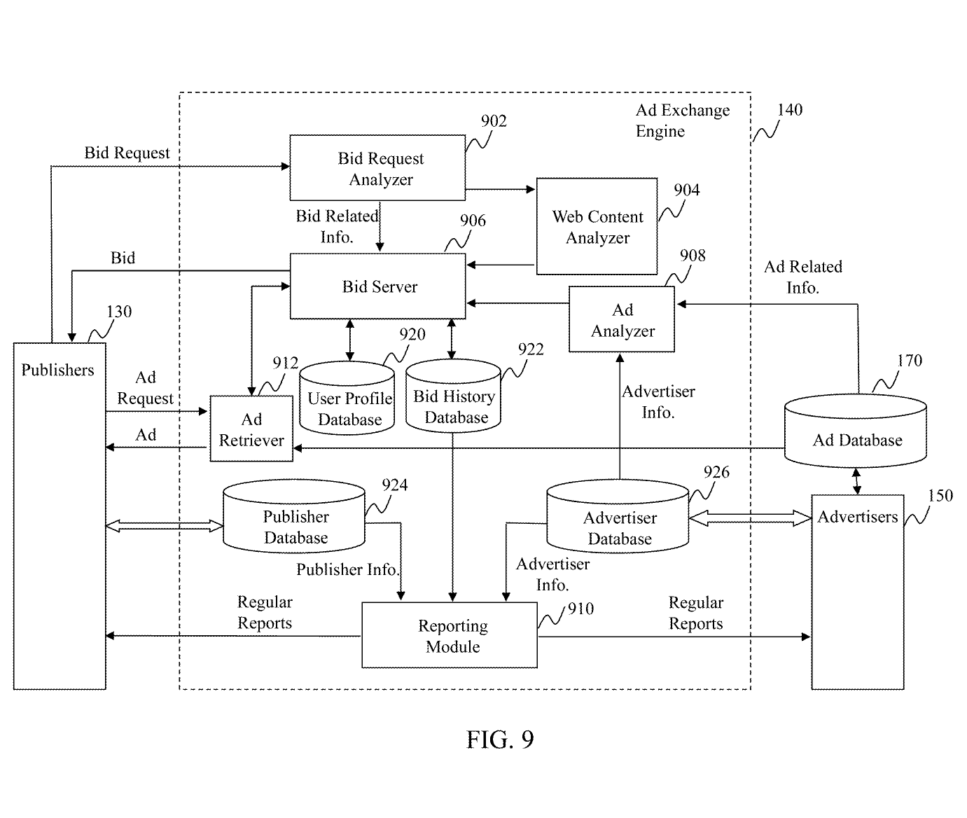

Turning now to ad exchange architecture, FIG. 9 illustrates an exemplary diagram of an ad exchange engine 140 to generate an online bid, according to an embodiment of the present teaching. The ad exchange engine 140 may be the ad exchange engine 140 in FIG. 1 or FIG. 2. The ad exchange engine 140 in this example includes a bid request analyzer 902, a web content analyzer 904, a bid server 906, an ad analyzer 908, a reporting module 910, and an ad retriever 912. The bid request analyzer 902 is configured to receive and analyze a bid request from e.g. the publisher 130. The bid request is for one or more ad opportunities related to an online service, e.g. a web page, a web application, an online game, or an online music service. The bid request can be analyzed to generate bid related information including information about, e.g., the bid mode, the online service, and/or the ad opportunity. The bid request analyzer 902 may send the bid related information to the web content analyzer 904 and the bid server 906.

The web content analyzer 904 is configured to analyze content of the online service identified by the bid request analyzer 902 based on the bid request. In one example, if the online service is the web page 2400 as shown in FIG. 24, the web content analyzer 904 may analyze content of the web page 2400 to determine topics related to the content. In another example, if the online service is an online music player, the web content analyzer 904 may analyze content of the popular songs listed in the player to determine topics related to the popular songs. In both examples, the determined topics may be utilized for determining an advertisement and/or a bid.

The ad analyzer 908 is configured to obtain and analyze information related to advertisements from the ad database 170 and information related to advertisers from an advertiser database 926 in the ad exchange engine 140. The advertiser database 926 may store information related to different advertisers. As shown in FIG. 9, both the ad database 170 and the advertiser database 926 are connected to the advertisers 150 and may exchange information with the advertisers 150. The advertiser information obtained from the advertiser database 926 and the ad related information obtained from the ad database 170 may include personal or demographic information of each advertiser, price each advertiser is willing to bid for a given advertisement opportunity, features of advertisements of each advertiser, or bidding strategy or prices by each advertiser, etc. The ad analyzer 908 may send the above mentioned information to the bid server 906 for generating a bid.

The bid server 906 is configured to determine one or more advertisements and generate an online bid associated with the one or more advertisements. The one or more advertisements may be determined based on bid related information, determined topics from content analysis, advertiser information, and/or ad related information. For example, if the determined topics about the online service are mainly about sports, the bid server 906 may determine a sport-related advertisement for an advertiser. If there are multiple advertisers in the advertiser database 926 having a sport-related advertisement, or there are multiple sport-related advertisements from the same advertiser, a separate bidding process can be performed among the multiple advertisers regarding multiple advertisements to determine a winner whose bid associated with the corresponding advertisement will be submitted to the publisher 130. It would be understood that one advertiser may be willing to bid with a different price for a different advertisement.

In one embodiment, the bid server 906 may determine the bid mode associated with the bid request, based on the bid related information from the bid request analyzer 902. The bid server 906 may then determine a manner to coordinate multiple advertisements in accordance with the determined bid mode. For example, if the bid request is in accordance with bid mode II, the user's past behavior with respect to a first advertisement will be needed to determine a second advertisement. Accordingly, the bid server 906 may retrieve user behavior from a user profile database 920 in the ad exchange engine 140. The ad exchange engine 140 may itself collect user behavior information or may receive user behavior information from the publisher 130. In another example, the user behavior information may be forwarded from the publisher 130 via the bid request. In accordance with bid mode II, the bid server 906 may determine a second advertisement based on the user's past behavior with respect to the first advertisement, where the first and second advertisements may be from a same advertiser or have similar topics. For example, if a user has previously viewed or dwelled on the brand advertisement 2410 of the 2400 in FIG. 24 for more than 20 times, and when the user logs in again to request for the same web page 2400, an ad exchange engine representing the advertiser of the brand advertisement 2410 may determine to bid for a second advertisement from the same advertiser and also related to flower delivery business. If the bid is accepted, the second advertisement may be located on the same web page 2400, e.g., as a stream advertisement among the first content stream 2420 or among the second content stream 2430.

After determining an advertisement, the bid server 906 may generate an online bid associated with the advertisement based on, e.g., the winning bid from a separate real-time bidding among the advertisers represented by the ad exchange engine 140, or historical bidding information retrieved from a bid history database 922 in the ad exchange engine 140. In one example, the historical bidding information may be stored in the bid history database 922 and analyzed offline by the bid server 906, i.e., before or without receiving any bid request from the publisher 130, or even when disconnected from the network 120. Thus, if it is determined not to participate in online bidding for a particular bid mode, based on the historical bidding data analyzed offline, big cost can be avoided by not running the separate real-time online bidding among the advertisers 150 represented by the ad exchange engine 140. A generated bid request may be sent to the publisher 130 by the bid server 906 and saved into the bid history database 922.

The ad retriever 912 is configured to receive an ad request from the publisher 130, retrieve one or more advertisements from the ad database 170 based on the ad request, and send the one or more advertisements to the publisher 130. According to one embodiment, the ad retriever 912 may send an ad index request to the bid server 906 based on the ad request, receive an ad index from the bid server 906, and retrieve the corresponding advertisements from the ad database 170 using the ad index. According to another embodiment, the bid information sent by the bid server 906 to the publisher 130 already includes an ad index, so that the publisher 130 can directly retrieve the corresponding one or more advertisements from the ad database 170, if the bid from the ad exchange engine 140 is accepted.

Whether the publisher 130 retrieves advertisements directly from the ad database 170 or through the ad exchange engine 140, the publisher 130 may inform the ad exchange engine 140 that the bid submitted by the ad exchange engine 140 is accepted. Then the bid server 906 may optionally update the user profile database and/or the bid history database, to record e.g., which bid won for which user.

The reporting module 910 is configured to generate reports based on historical data retrieved from the bid history database 922. The reports may include both a first report to an advertiser and a second report to a publisher.

In one embodiment, the reporting module 910 retrieves bid historical data from the bid history database 922 and advertiser information from the advertiser database 926. The bid historical data retrieved are related to bidding events joined by an advertiser, e.g., advertiser 150-1. The advertiser information includes information associated with the advertiser 150-1, such as features of advertisements stored in the ad database 170 by the advertiser 150-1, personal or demographic information of the advertiser 150-1, bidding strategy or prices stored in the advertiser database 926 by the advertiser 150-1, etc. Based on the bid historical data and the advertiser information related to the advertiser 150-1, a personalized advertiser report may be generated by the reporting module 910 for the advertiser 150-1. The personalized advertiser report may be generated and sent to the advertiser 150-1, either regularly like on a daily basis, or upon request e.g. by the advertiser 150-1.

In another embodiment, the reporting module 910 retrieves bid historical data from the bid history database 922 and publisher information from a publisher database 924 in the ad exchange engine 140. The bid historical data retrieved are related to bidding events initiated by a publisher, e.g., the publisher 130-1. The publisher information includes information associated with the publisher 130-1, such as predetermined bid modes for the bid requests from the publisher 130-1, personal or demographic information of the publisher 130-1, etc. Based on the bid historical data and the publisher information related to the publisher 130-1, a personalized publisher report may be generated by the reporting module 910 for the publisher 130-1. The personalized publisher report may be generated and sent to the publisher 130-1, either regularly like on a daily basis, or upon request e.g. by the publisher 130-1.

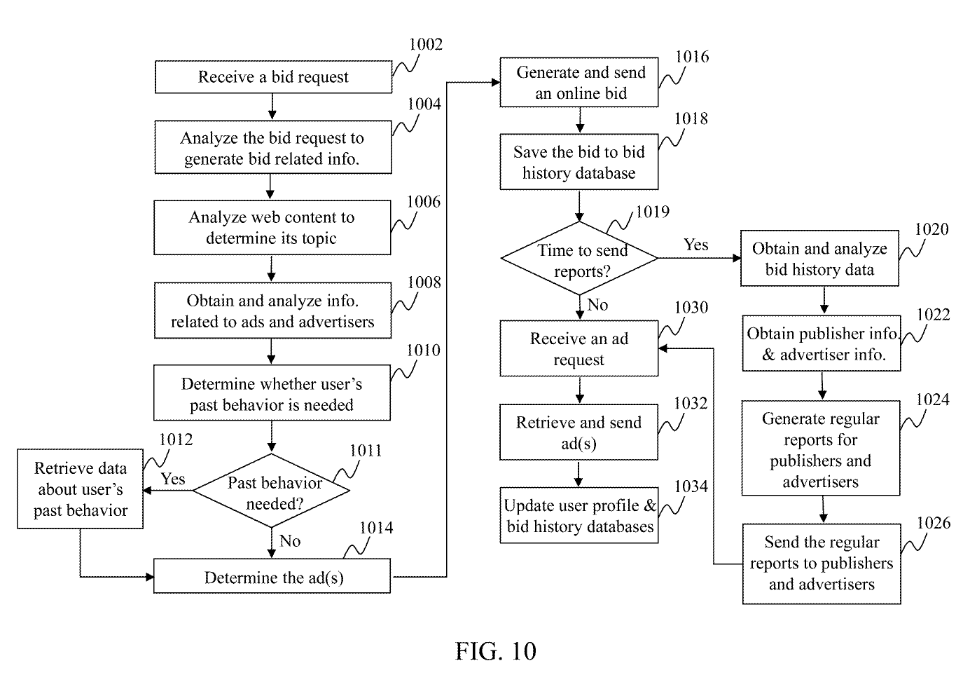

FIG. 10 is a flow chart of an exemplary process performed at an ad exchange engine, e.g. the ad exchange engine 140 in FIG. 9, according to an embodiment of the present teaching. Starting at 1002, a bid request is received, e.g. from the publisher 130. The bid request may be related to one or more advertisement opportunities associated with an online service to be provided to a user. At 1004, the bid request is analyzed to generate bid related information. At 1006, content about the online service is analyzed to determine one or more topics related to the content. At 1008, information related to advertisements and advertisers is obtained and analyzed.

At 1010, it is determined whether past behavior of the user is needed, based on e.g., a bid mode identified from the bid related information. The result of the determination is checked at 1011. If past behavior is needed, at 1012, past behavior information of the user is retrieved and the process moves to 1014. If past behavior is not needed, the process directly goes to 1014.

At 1014, one or more advertisements are determined, e.g., based on the user's past behavior, if it is needed. At 1016, an online bid is generated and sent, e.g., to the publisher 130. At 1018, the bid is saved into the bid history database 922.

At 1019, whether it is time to send reports is checked. If so, at 1020, bid history data is obtained and analyzed. At 1022, information about publishers and advertisers is obtained. Then regular reports are generated for publishers and advertisers at 1024 and sent to the publishers and advertisers at 1026. The process may then go to 1030. Otherwise, if it is not time to send reports, the process goes directly from 1019 to 1030.

At 1030, an ad request is received, e.g. from the publisher 130. At 1032, one or more advertisements are retrieved and sent in response to the ad request. Optionally at 1034, the user profile database and/or the bid history database can be updated.

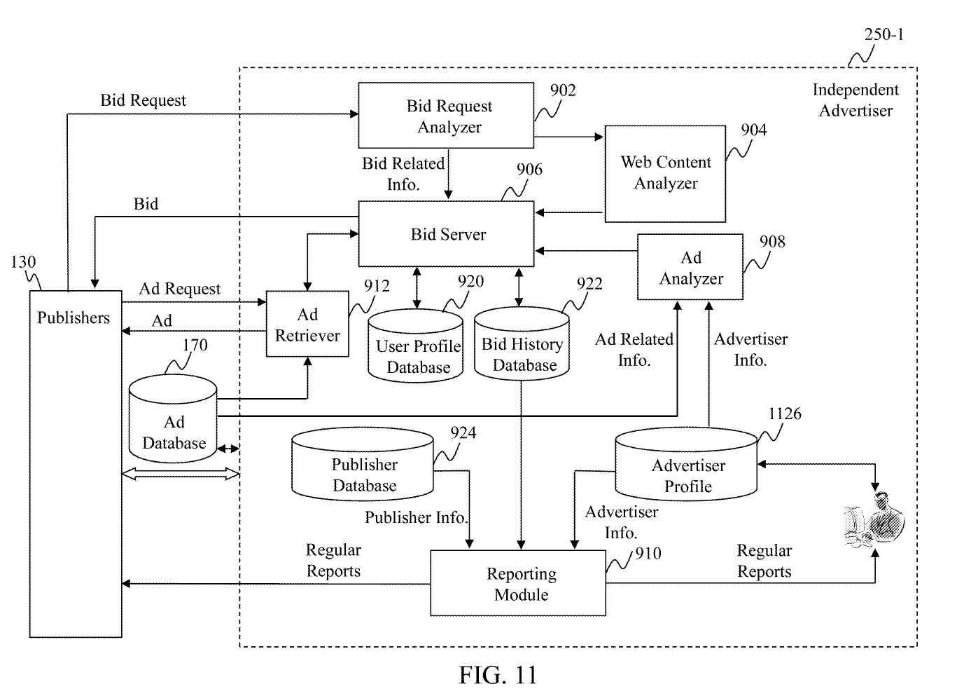

FIG. 11 illustrates an exemplary diagram of an independent advertiser, e.g., the independent advertiser 250-1 in FIG. 2, according to an embodiment of the present teaching. Compared to the ad exchange engine 140 in FIG. 9, the independent advertiser 250-1 in this example does not include the advertiser database 926 storing information for multiple advertisers but includes advertiser profile 1126 storing information related to a single advertiser, i.e. the independent advertiser 250-1, as shown in FIG. 11. The independent advertiser 250-1 can independently perform online bidding regarding its own advertisements, while the ad exchange engine 140 can perform online bidding regarding advertisements of multiple advertisers.

Compared to the ad analyzer 908 in the ad exchange engine 140, the ad analyzer 908 in the independent advertiser 250-1 is configured for obtaining and analyzing information related to the independent advertiser 250-1 from the advertiser profile 1126 and information related to advertisements of the independent advertiser 250-1 from the ad database 170, and sending the above mentioned information to the bid server 906 for generating a bid.

Compared to the reporting module 910 in the ad exchange engine 140, the reporting module 910 in the independent advertiser 250-1 retrieves bid historical data related solely to the independent advertiser 250-1 and generates a regular or requested report, based on the bid historical data and the advertiser information related to the independent advertiser 250-1. The report is generated for the independent advertiser 250-1 itself and can be provided to a manager, e.g. a human manager, of the independent advertiser 250-1.

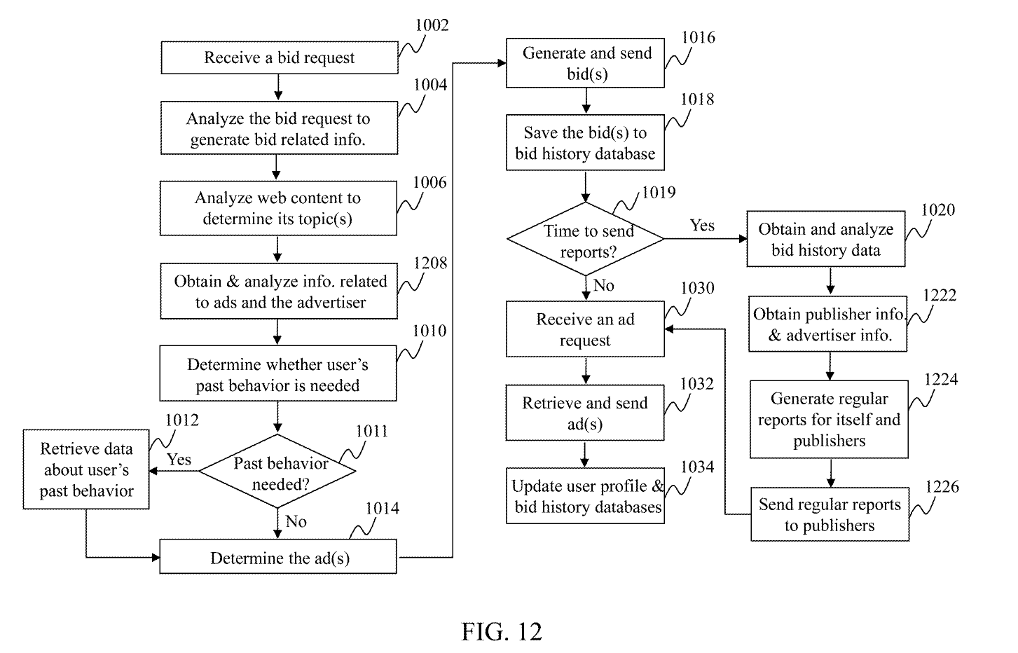

FIG. 12 is a flow chart of an exemplary process performed at an independent advertiser, e.g. the independent advertiser 250-1 in FIG. 11, according to an embodiment of the present teaching. Starting at 1002, a bid request is received, e.g. from the publisher 130. The bid request may be related to one or more advertisement opportunities associated with an online service to be provided to a user. At 1004, the bid request is analyzed to generate bid related information. At 1006, content about the online service is analyzed to determine one or more topics related to the content. At 1208, information related to advertisements and the independent advertiser 250-1 is obtained and analyzed.

At 1010, it is determined whether past behavior of the user is needed, based on e.g. a bid mode identified from the bid related information. The result of the determination is checked at 1011. If past behavior is needed, at 1012, past behavior information of the user is retrieved and the process moves to 1014. If past behavior is not needed, the process directly goes to 1014.

At 1014, one or more advertisements are determined, e.g. based on the user's past behavior if it is needed. At 1016, an online bid is generated and sent, e.g. to the publisher 130. At 1018, the bid is saved into the bid history database 922.

At 1019, whether it is time to send reports is checked. If so, at 1020, bid history data is obtained and analyzed. At 1222, information about publishers and the independent advertiser 250-1 is obtained. Then regular reports are generated for publishers and the independent advertiser 250-1 itself at 1224. At 1226, the regular reports for publishers are sent to the publishers. The process may then go to 1030. Otherwise, if it is not time to send reports, the process goes directly from 1019 to 1030.

At 1030, an ad request is received, e.g. from the publisher 130. At 1032, one or more advertisements are retrieved and sent in response to the ad request. Optionally at 1034, the user profile database and/or the bid history database can be updated.

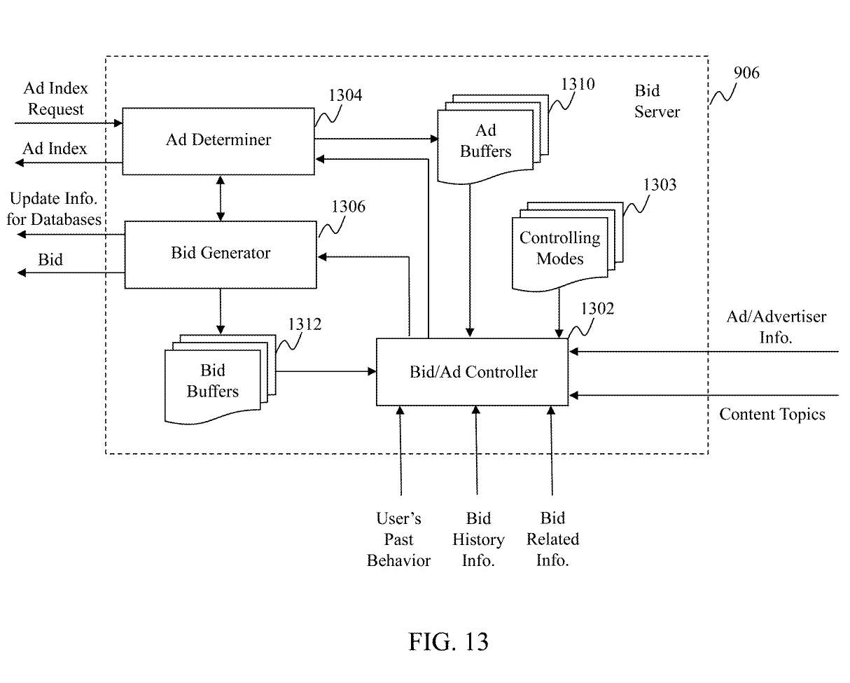

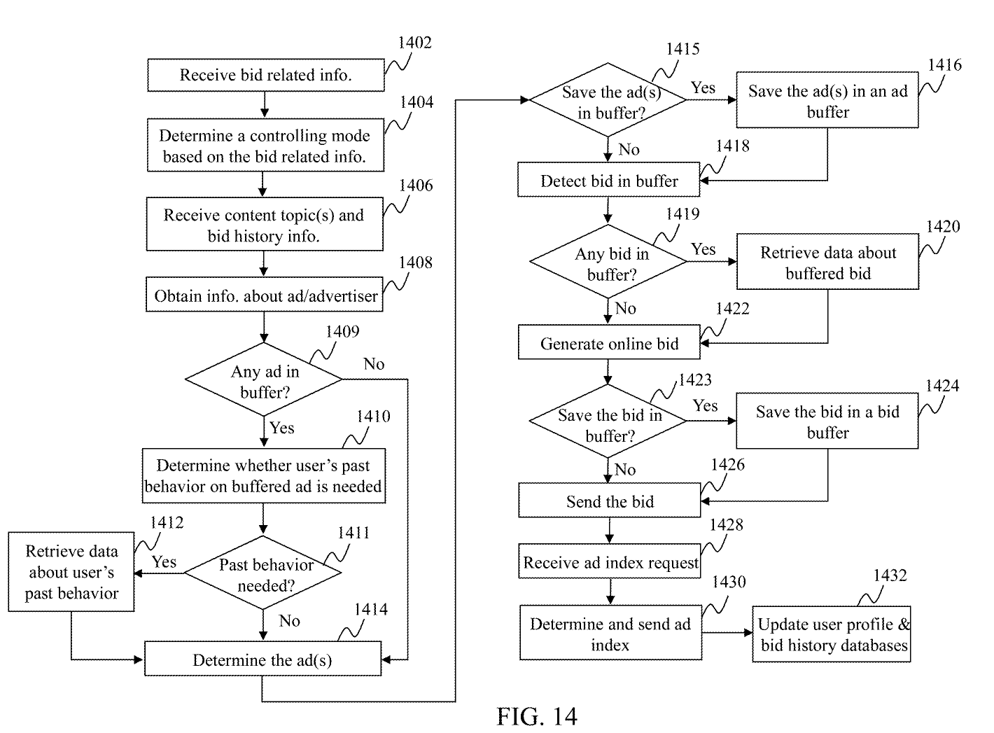

FIG. 13 illustrates an exemplary diagram of a bid server 906 in an ad exchange engine, e.g., the ad exchange engine 140 in FIG. 9, or in an independent advertiser, e.g. the independent advertiser 250-1 in FIG. 11, according to an embodiment of the present teaching. The following description regarding FIG. 13 and FIG. 14 will focus on the bid server 906 in the ad exchange engine 140. It can be understood that a similar description can be applied to the bid server 906 in the independent advertiser 250-1. The bid server 906 in this example includes a bid/ad controller 1302, an ad determiner 1304, and a bid generator 1306.

The bid/ad controller 1302 may receive bid related information, e.g., from the bid request analyzer 902. The bid/ad controller 1302 may determine the bid mode for the current bidding based on the bid related information. In accordance with the bid mode, the bid/ad controller 1302 may determine or select one of the controlling modes 1303 stored in the bid server 906. A controlling mode describes a manner in which the ad exchange engine 140 should perform, in accordance with a bid mode. For example, in accordance with bid mode IV, a controlling mode IV describes that the ad exchange engine 140 should submit a high bid for the first advertisement, if the ad exchange engine 140 has a good candidate for the second advertisement and wants a chance for the second bidding.

In one example, each controlling mode corresponds to a bid mode. Therefore, the bid related information may merely include an index to a bid mode, and the bid/ad controller 1302 can determine a corresponding controlling mode based on the index.

Different ad exchange engines may have different controlling modes, even corresponding to the same bid mode. For example, an ad exchange engine representing multiple advertisers who prefer bundled bids may have a controlling mode I to submit a bid with highest possible price, in accordance with bid mode I; while an independent advertiser who does not have many advertisements and does not like bundled bids may have another controlling mode I to submit a low priced bid or submit no bid at all, in accordance with bid mode I.

The bid/ad controller 1302 may also receive content topics of the online service to be provided to the user from the web content analyzer 904, information about the advertisers and advertisements from the ad analyzer 908, and bid history information from the bid history database 922. The bid/ad controller 1302 may send the above mentioned information to the ad determiner 1304 for determining an advertisement and to the bid generator 1306 for generating an online bid associated with the determined advertisement. A controlling mode may control how an advertisement is determined and/or how high a bid is generated according to different situations with respect to these information. In one example, a controlling mode I may control the bid generated with a low price when the user is requesting a search result about a topic of “weather”, since the user might not have enough time to pay attention to advertisements on the search result page in this situation. In another example, a controlling mode V may control the bid generated with a highest possible price regarding a stream advertisement about music DVD sale when the user is listening to online music related to the same DVD, and/or when the user has previously clicked on a brand advertisement about the DVD for many times.

In accordance with a controlling mode, the bid/ad controller 1302 may determine whether the user's past behavior is needed for determining an advertisement. For example, in accordance with controlling mode V and bid mode V, a second advertisement will be determined based on the user's past behavior with respect to the first advertisement. After the first advertisement is determined, it can be stored in one of ad buffers 1310 in the bid server 906. Thus, if the bid/ad controller 1302 detects that there is an advertisement stored in an ad buffer in accordance with controlling mode V, it may retrieve the user's past behavior with respect to the advertisement from the user profile database 920, e.g., based on a user ID identified from the bid related information. It would be understood that when the ad exchange engine 140 receives a second bid request in accordance with bid mode V, the ad exchange engine 140 may determine that the received bid request is a follow-up request sequentially after a previous bid request, instead of a brand new request like the request in bid mode I, based on, e.g., a reference number associated with each bid request.

The ad determiner 1304 is configured to determine one or more advertisements based on the information received from the bid/ad controller 1302, save the determined advertisements into an ad buffer 1310, and send the determined advertisements to the bid generator 1306 for generating an online bid. The ad determiner 1304 may also receive an ad index request for one or more advertisements from the ad retriever 912, when, e.g., a bid associated with the one or more advertisements was accepted. The ad determiner 1304 may determine and send the ad index to the ad retriever 912 as a response to the ad index request.

The bid generator 1306 is configured to generate an online bid associated with the advertisement received from the ad determiner 1304, based on information received from the bid/ad controller 1302. For example, if the bid server 906 has won a bidding with a bid of $10 regarding two game related advertisements on an online game, in accordance with controlling mode I and bid mode I, the bid generator 1306 may generate an online bid of $10 again for another two game related advertisements, if the current bid request is also related to an online game and bid mode I. But if the previous two game related advertisements did not receive a good ROI, e.g., the user did not perform any activity or interaction with respect to the advertisements, the bid generator 1306 may generate an online bid of $5 to save cost this time.

The bid generator 1306 is also configured to save the generated bid into one of bid buffers 1312 in the bid server 906. In one embodiment, the bid buffers 1312 may store a previous bid, so that the bid/ad controller 1302 may retrieve the previous bid from one of the bid buffers 1312 and determine how aggressive the next bid should be. For example, after the ad exchange engine 140 sends the first and second online bids to the publisher 130 according to bid mode VII, as shown in FIG. 21A, the bid generator 1306 in the ad exchange engine 140 may save the first and second online bids into the bid buffer 1312. Thus, if the ad exchange engine 140 receives a third bundled bid request from the publisher 130, the bid/ad controller 1302 in the ad exchange engine 140 may retrieve the first and second online bids from the bid buffer 1312, and the bid generator 1306 may generate a third online bid with a price at least equal to a sum of the prices of the first and second bids, if the ad exchange engine 140 wants to win the bidding.

The bid generator 1306 is also configured to send the generated bid to the publisher 130 and optionally send updated information to the databases, e.g., to the bid history database 922, when a generated bid has been accepted by the publisher 130.

FIG. 14 is a flow chart of an exemplary process performed at a bid server, e.g., the bid server 906 in FIG. 13, according to an embodiment of the present teaching. Starting at 1402, bid related information is received. At 1404, a controlling mode is determined based on the bid related information. At 1406, one or more topics related to content of the online service to be provided to a user, as well as bid history information, are received. At 1408, information about the advertisers represented by the ad exchange engine 140 and their advertisements is obtained.

At 1409, whether any advertisement is in an ad buffer is checked. If so, at 1410, it is determined whether the user's past behavior on the buffered ad is needed. The result of the determination is checked at 1411. If the user's past behavior is needed, at 1412, data about the user's past behavior is retrieved and the process goes to 1414. If the user's past behavior is not needed, the process goes directly from the 1411 to 1414. If there is no advertisement in any ad buffer at 1409, the process goes directly from 1409 to 1414.

At 1414, one or more advertisements are determined, e.g. based on the determined controlling mode, the received content topics, the received bid history information, and/or the obtained information about the advertisers represented by the ad exchange engine 140 and their advertisements. At 1415, it is determined whether to save the determined one or more advertisements in an ad buffer, e.g. based on the determined controlling mode. If so, at 1416, the determined one or more advertisements are saved in an ad buffer and the process goes to 1418. Otherwise, the process goes directly to 1418.

At 1418, whether there is any bid in a bid buffer is detected. The result of the detection is checked at 1419. If there is a buffered bid, at 1420, data about the buffered bid is retrieved and the process goes to 1422. Otherwise, if there is not a buffered bid, the process goes directly from 1419 to 1422. At 1422, an online bid is generated.

Proceeding to 1423, whether to save the online bid in a bid buffer is determined. If so, at 1424, the online bid is saved in a bid buffer and the process goes to 1426. Otherwise, the process goes directly from 1423 to 1426.

At 1426, the online bid is sent out, e.g. to the publisher 130. At 1428, an ad index request is received. At 1430, an ad index is determined and sent in response to the ad index request. At 1432, the user profile database and the bid history database can be updated. The process from 1428 to 1432 can be optional in accordance with various embodiments.

It would be understood that in any of the flowcharts described above, the order of the steps may be different in accordance with different embodiments. For example, in FIG. 14, the order of 1406 and 1408 can be switched in accordance with one embodiment of the present teaching.

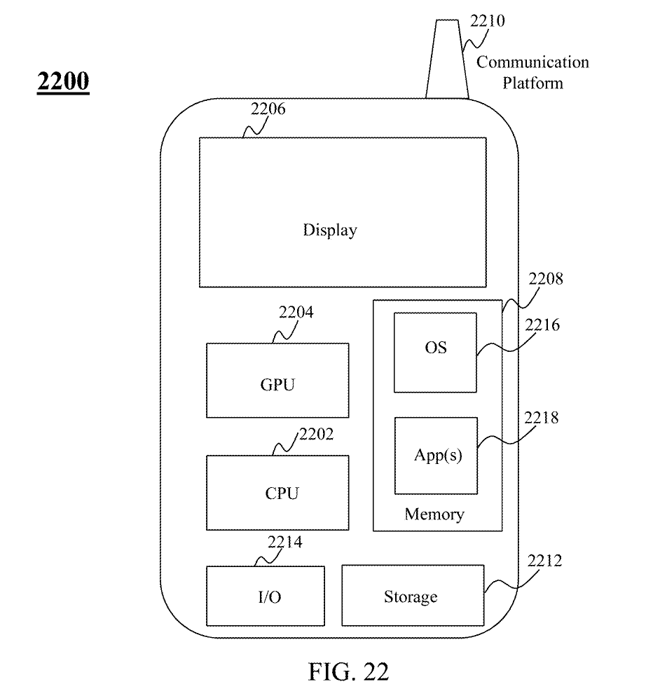

FIG. 22 depicts a general mobile device architecture on which the present teaching can be implemented. In this example, the user device 110 is a mobile device 2200, including but is not limited to, a smart phone, a tablet, a music player, a handled gaming console, a GPS receiver, a wearable computing device (e.g., glasses, wrist watch, etc.). The mobile device 2200 in this example includes one or more central processing units (CPUs) 2202, one or more graphic processing units (GPUs) 2204, a display 2206, a memory 2208, a communication platform 2210, such as a wireless communication module, storage 2212, and one or more input/output (I/O) devices 2219. Any other suitable component, such as but not limited to a system bus or a controller (not shown), may also be included in the mobile device 2200. As shown in FIG. 22, a mobile operating system 2216, e.g., iOS, Android, Windows Phone, etc., and one or more applications 2218 may be loaded into the memory 2208 from the storage 2212 in order to be executed by the CPU 2202. The applications 2218 may include a web browser or any other suitable mobile search apps. Execution of the applications 2218 may cause the mobile device 2200 to perform some processing as described before. For example, the display of content items and search results is made by the GPU 2204 in conjunction with the display 2206. User inputs of search queries are received via the I/O devices 2214 and sent to the search engine system 130 via the communication platform 2210.

To implement the present teaching, computer hardware platforms may be used as the hardware platform(s) for one or more of the elements described herein. The hardware elements, operating systems, and programming languages of such computers are conventional in nature, and it is presumed that those skilled in the art are adequately familiar therewith to adapt those technologies to implement the processing essentially as described herein. A computer with user interface elements may be used to implement a personal computer (PC) or other type of work station or terminal device, although a computer may also act as a server if appropriately programmed. It is believed that those skilled in the art are familiar with the structure, programming, and general operation of such computer equipment and as a result the drawings should be self-explanatory.

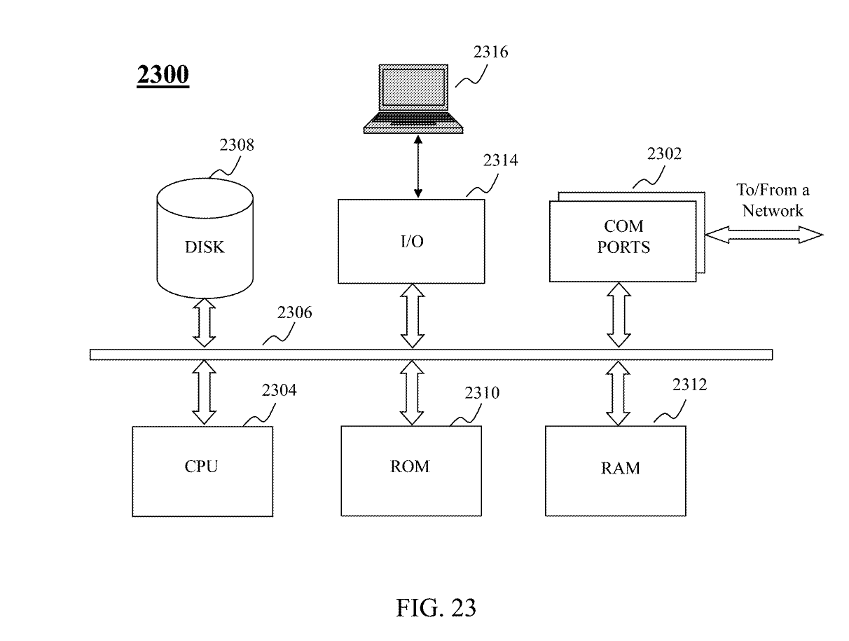

FIG. 23 depicts a general computer architecture on which the present teaching can be implemented and has a functional block diagram illustration of a computer hardware platform that includes user interface elements. The computer may be a general-purpose computer or a special purpose computer. This computer 2300 can be used to implement any components of the user satisfaction evaluation architecture as described herein. Different components of the system, e.g., as depicted in FIGS. 1 and 2, can all be implemented on one or more computers such as computer 2300, via its hardware, software program, firmware, or a combination thereof. Although only one such computer is shown, for convenience, the computer functions relating to user satisfaction evaluation may be implemented in a distributed fashion on a number of similar platforms, to distribute the processing load.

The computer 2300, for example, includes COM ports 2302 connected to and from a network connected thereto to facilitate data communications. The computer 2300 also includes a CPU 2304, in the form of one or more processors, for executing program instructions. The exemplary computer platform includes an internal communication bus 2306, program storage and data storage of different forms, e.g., disk 2308, read only memory (ROM) 2310, or random access memory (RAM) 2312, for various data files to be processed and/or communicated by the computer, as well as possibly program instructions to be executed by the CPU 2304. The computer 2300 also includes an I/O component 2314, supporting input/output flows between the computer and other components therein such as user interface elements 2316. The computer 2300 may also receive programming and data via network communications.

Hence, aspects of the method of advertisement coordination, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will recognize that the present teachings are amenable to a variety of modifications and/or enhancements. For example, although the implementation of various components described above may be embodied in a hardware device, it can also be implemented as a software only solution—e.g., an installation on an existing server. In addition, the units of the host and the client nodes as disclosed herein can be implemented as a firmware, firmware/software combination, firmware/hardware combination, or a hardware/firmware/software combination.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

What is claimed is:

1. A method, implemented on a machine having at least one processor, storage, and a communication platform connected to a network for generating an online bid, comprising:
receiving, via the communication platform, a bid request with respect to a plurality of advertisement opportunities, wherein the plurality of advertisement opportunities is related to an online service;
determining a plurality of advertisements in accordance with the plurality of advertisement opportunities;
generating an online bid associated with the plurality of advertisements based on the bid request; and
transmitting the online bid as a response to the bid request.

2. The method of claim 1, wherein determining the plurality of advertisements comprises:
determining a first advertisement of the plurality of advertisements to be presented to a user,
obtaining the user's behavior with respect to the first advertisement, and
determining a second advertisement of the plurality of advertisements based on the user's behavior with respect to the first advertisement.

3. The method of claim 2, wherein the user's behavior includes information related to at least one of:
a number of times the user has viewed content associated with the first advertisement;
a number of times the user has clicked the first advertisement; and
a number of times the user has taken an action related to shopping of content associated with the first advertisement.

4. The method of claim 2, wherein the first and second advertisements have similarity with respect to at least one of: advertisement category, targeting user group, advertisement description, and landing web page.

5. The method of claim 1, further comprising analyzing the bid request to generate bid related information that includes: contextual information about the online service and/or a bid mode associated with the bid request, wherein at least one advertisement of the plurality of advertisements is determined based on the bid related information.

6. The method of claim 1, further comprising at least one of the following:
storing the plurality of advertisements in a first buffer; and
storing the online bid in a second buffer.

7. A method, implemented on a machine having at least one processor, storage, and a communication platform connected to a network for managing online bidding, comprising:
generating a bid request with respect to a plurality of advertisement opportunities, wherein the plurality of advertisement opportunities is related to an online service;
transmitting, via the communication platform, the bid request to one or more online bidders;
receiving one or more online bids from the one or more online bidders, wherein each of the one or more online bids is associated with the plurality of advertisement opportunities;
determining a winning bid from the one or more online bids; and
identifying a plurality of advertisements associated with the winning bid.

8. The method of claim 7, further comprising:
receiving a request for the online service from a user;
obtaining content related to the online service based on the request; and
detecting the plurality of advertisement opportunities based on the content, wherein the content and the plurality of advertisements are to be presented to the user.

9. The method of claim 8, wherein generating the bid request further comprises:
obtaining information related to the online service and/or the user;
retrieving one or more bid modes based on the obtained information;
selecting a bid mode from the one or more bid modes; and
generating the bid request based on the selected bid mode.

10. The method of claim 7, wherein the one or more online bidders include at least one of:
an ad exchange engine representing a plurality of advertisers; and
an independent advertiser that is capable of bidding on its own.

11. The method of claim 7, further comprising at least one of the following:
storing the plurality of advertisements in a first buffer; and
storing the winning bid in a second buffer.

12. A system, having at least one processor, storage, and a communication platform connected to a network for generating an online bid, comprising:
a bid request analyzer configured to receive, via the communication platform, a bid request with respect to a plurality of advertisement opportunities, wherein the plurality of advertisement opportunities is related to an online service;
an ad determiner configured to determine a plurality of advertisements in accordance with the plurality of advertisement opportunities; and
a bid generator configured to generate an online bid associated with the plurality of advertisements based on the bid request and transmit the online bid as a response to the bid request.

13. The system of claim 12, wherein the ad determiner is further configured to:
determine a first advertisement of the plurality of advertisements to be presented to a user,
obtain the user's behavior with respect to the first advertisement, and determine a second advertisement of the plurality of advertisements based on the user's behavior with respect to the first advertisement.

14. The system of claim 13, wherein the user's behavior includes information related to at least one of:
a number of times the user has viewed content associated with the first advertisement;
a number of times the user has clicked the first advertisement; and
a number of times the user has taken an action related to shopping of content associated with the first advertisement.

15. The system of claim 13, wherein the first and second advertisements have similarity with respect to at least one of: advertisement category, targeting user group, advertisement description, and landing web page.

16. A system, having at least one processor, storage, and a communication platform connected to a network for managing online bidding, comprising:
a bid requestor configured to generate a bid request with respect to a plurality of advertisement opportunities and transmit the bid request to one or more online bidders, wherein the plurality of advertisement opportunities is related to an online service;
a bid receiver configured to receive one or more online bids from the one or more online bidders, wherein each of the one or more online bids is associated with the plurality of advertisement opportunities;
a bid selector configured to determine a winning bid from the one or more online bids; and
an ad requestor configured to identify a plurality of advertisements associated with the winning bid.

17. The system of claim 16, further comprising:
a web request processor configured to receive a request for the online service from a user;
a web generator/updater configured to obtain content related to the online service based on the request; and
an ad space detector configured to detect the plurality of advertisement opportunities based on the content, wherein the content and the plurality of advertisements are to be presented to the user.

18. The system of claim 17, wherein the bid requestor comprises:
a bid request controller configured to obtain information related to the online service and/or the user;
a bid mode analyzer configured to retrieve one or more bid modes based on the obtained information and select a bid mode from the one or more bid modes; and
a bid request generator configured to generate the bid request based on the selected bid mode.

19. The system of claim 16, wherein the one or more online bidders include at least one of:
an ad exchange engine representing a plurality of advertisers; and
an independent advertiser that is capable of bidding on its own.

20. A machine-readable tangible and non-transitory medium having information for generating an online bid, wherein the information, when read by the machine, causes the machine to perform the following:
receiving, via the communication platform, a bid request with respect to a plurality of advertisement opportunities, wherein the plurality of advertisement opportunities is related to an online service;
determining a plurality of advertisements in accordance with the plurality of advertisement opportunities;
generating an online bid associated with the plurality of advertisements based on the bid request; and
transmitting the online bid as a response to the bid request.

21. The medium of claim 20, wherein determining the plurality of advertisements comprises:
determining a first advertisement of the plurality of advertisements to be presented to a user,
obtaining the user's behavior with respect to the first advertisement, and determining a second advertisement of the plurality of advertisements based on the user's behavior with respect to the first advertisement.

22. A machine-readable tangible and non-transitory medium having information for managing online bidding, wherein the information, when read by the machine, causes the machine to perform the following:
generating a bid request with respect to a plurality of advertisement opportunities, wherein the plurality of advertisement opportunities is related to an online service;
transmitting, via the communication platform, the bid request to one or more online bidders;
receiving one or more online bids from the one or more online bidders, wherein each of the one or more online bids is associated with the plurality of advertisement opportunities;
determining a winning bid from the one or more online bids; and
identifying a plurality of advertisements associated with the winning bid.
